(19) United States
(12) Patent Application Publication
(10) Pub. No.: US 2019/0043001 A1
(43) Pub. Date: Feb. 7, 2019

(54) SYSTEMS AND METHODS FOR SCHEDULING EN ROUTE PRODUCT DELIVERY

(71) Applicant: MICROSOFT TECHNOLOGY LICENSING, LLC, Redmond, WA (US)

(72) Inventors: Muiris WOULFE, Dublin (IE); Andreas BALZER, Dublin (IE); Alan MULHALL, Dublin (IE)

(21) Appl. No.: 15/667,458

(22) Filed: Aug. 2, 2017

(51) Int. Cl. G06Q 10/08; G01C 21/34; G06Q 50/30

(52) U.S. Cl. CPC G06Q 10/083; G06Q 50/30; G01C 21/3438

(57) ABSTRACT

A delivery vehicle transfers a product to a receiving vehicle that is operating on a roadway system and is en route to a destination-location. The delivery vehicle is dispatched with the product along a specific route that partially overlaps with another route that the receiving vehicle is traveling on towards the destination-location. The delivery vehicle and the receiving vehicle rendezvous with one another on a portion of the roadway system that is common to both vehicles' respective routes. Once the delivery vehicle is within the vicinity of the receiving vehicle, the delivery vehicle approaches the receiving vehicle and opens a compartment containing the product to enable an occupant of the receiving vehicle to obtain the product. In one example, the compartment is affixed to a robotic-arm that the delivery vehicle extends towards a window of the receiving vehicle.

### BACKGROUND

Delivery services enable people to purchase products remotely from a source (e.g., a retailer and/or restaurant) and have those products delivered to their home, office and/or any other designated location such as a hotel or Airbnb. Such services provide a convenience for consumers, saving them time and resources while eliminating the need for a traditional pick-up. For example, a person may go online to purchase a sandwich from a restaurant and instruct the restaurant to deliver the sandwich to their office during his or her lunch hour. Unfortunately, conventional delivery services provide little or no benefit when time is of the essence and it is desirable to obtain a product while traveling between locations. Under these circumstances, a person must typically deviate from his or her route and physically go to a source of the needed product prior to continuing on to their destination. For example, a busy professional's only opportunity to eat lunch may occur between meetings while the professional is traveling across town from one meeting to another. Unfortunately, to mitigate the risk of being late to his or her next meeting, the busy professional may decide against deviating to a restaurant and go directly to the location of the next meeting without getting any lunch.

Without the ability to obtain a product when and where the product is desired while traveling between locations, people typically are forced to choose between the inconvenience of physically going to a source for the product or continuing directly to their destination without obtaining the product. It is with respect to these and other considerations that the disclosure made herein is presented.

### SUMMARY

This disclosure describes systems and techniques that facilitate a product being transferred from a delivery vehicle to a receiving vehicle that is operating on a roadway system and is en route to a destination-location. Generally described, the delivery vehicle is dispatched on the roadway system to carry the product along a specific route that partially overlaps with another route on which the receiving vehicle is traveling towards the destination-location. The delivery vehicle can be an automated vehicle or a manually driven vehicle that is directed along a determined route. The delivery vehicle and the receiving vehicle rendezvous with one another on a portion of the roadway system that is common to both vehicles' respective routes. Once the delivery vehicle is within the vicinity of the receiving vehicle, the delivery vehicle approaches the receiving vehicle to facilitate a transfer of the product to the receiving vehicle. The disclosed systems and techniques thus eliminate or mitigate the need for people with restricted schedules to choose between the first inconvenient option of diverting their route to pick up the product at a source location, or the second inconvenient option of going without the product and continuing on to the destination-location. Accordingly, the disclosed systems and techniques represent a substantial advance over conventional delivery services.

In an illustrative implementation, a system receives order data that indicates a selection of a product for delivery to a receiving vehicle that is operating on a roadway system. The order data may be generated by a computing device such as, for example, an onboard computing system that is integrated into the receiving vehicle (e.g., an in-dash navigation system) and/or a hand-held computing device of a consumer (e.g., a smartphone). The order data may be generated by other systems, including phone-based systems that involve a manual or automated service operator. Order data can be obtained by a system, which includes either receiving the data or generating the data.

The system may determine first route data that indicates a first route on the roadway system that the receiving vehicle is expected to use to navigate to the destination-location. The first route data may further indicate a first travel-schedule of the receiving vehicle with respect to the first route. The first travel-schedule may indicate a specific time at which the receiving vehicle is expected to depart from an initial-location toward the destination-location, a specific time at which the receiving vehicle is expected to reach one or more points along the first route, a specific time at which the receiving vehicle is expected to arrive at the destination-location, and/or any other temporal information that may be usable to determine when and where the self-driving delivery vehicle may be able to rendezvous with the receiving vehicle to deliver the product. In some configurations, as will be explained in more detail below, the system can also select a source of the product depending on the route of the receiving vehicle, the location of the projected rendezvous area, and other factors such as the availability of product, etc. In such embodiments, the first route can be adjusted to cause the delivery vehicle to navigate to the location of the source and then travel to the rendezvous area.

In response to receiving the order data, the system generates second route data that indicates a second route on the roadway system for the self-driving delivery vehicle to navigate along to rendezvous with the receiving vehicle while the receiving vehicle is en route to the destination-location. The second route data may in some instances indicate a second travel-schedule that defines a rendezvous area along a portion of the second route that is common to the first route. Stated alternatively, in conjunction with the first travel-schedule that indicates when the receiving vehicle is expected to be at one or more predetermined locations along the first route, the second travel-schedule may be designed to control when and where the self-driving delivery vehicle will rendezvous with the receiving vehicle.

For illustrative purposes, consider a scenario in which the first travel-schedule indicates that the receiving vehicle is expected to be traveling along an interstate highway and is further expected to reach a specific on-ramp to the interstate highway at a specific time. Under these circumstances, the second travel-schedule may be specifically tailored to cause the self-driving delivery vehicle to merge onto the interstate highway from the on-ramp at the specific time that the receiving vehicle is expected to pass the on-ramp. For example, the second travel-schedule may cause the self-driving delivery vehicle to reach the on-ramp shortly before the receiving vehicle and to wait before merging onto the interstate highway until the specific time that the receiving vehicle is passing the on-ramp.

In some implementations, the system may be configured to obtain location data associated with the receiving vehicle wherein the location data indicates a substantially real-time location of the receiving vehicle. Thus, the self-driving delivery vehicle may be enabled to wait at the on-ramp (e.g., on a “shoulder” of the road) while monitoring the location data of the receiving vehicle to determine the precise moment to merge onto the interstate highway. As disclosed herein, the delivery vehicle can also perform other maneuvers to coordinate with the receiving vehicle. For instance, the delivery vehicle can account for other traffic and obstacles, e.g., perform overtaking maneuvers, etc. These examples are provided for illustrative purposes and are not to be construed as limiting. As other types of vehicles used in any environment, including environments with different types of pathways, e.g., beyond roads, can be used with the techniques disclosed herein.

In some configurations, the delivery vehicle can be scheduled to recharge or discharge based on the travel-schedule. Such actions and other suitable actions can be scheduled to add or utilize electricity from an energy grid to optimize energy use and potentially generate additional revenue. For instance, if a delivery vehicle is scheduled to wait for a threshold period of time, that delivery vehicle may be connected to a charging station to receive from, or deliver power to, an exertional energy source in exchange for a medium of compensation.

Once the self-driving delivery vehicle is within the vicinity of the receiving vehicle (e.g., once both vehicles are within the predefined rendezvous area), the system may cause the self-driving delivery vehicle to approach the receiving vehicle to achieve a distance between the vehicles that is close enough to facilitate a transfer of the product. For example, the self-driving delivery vehicle may be caused to pull up alongside the receiving vehicle while the receiving vehicle is traveling along the interstate highway. Thus, both velocity and direction of the delivery vehicle can be controlled to match that of the receiving vehicle. The self-driving delivery vehicle may then closely monitor a velocity and/or side-to-side steering movements of the receiving vehicle in order to safely achieve the distance between vehicles and determine on which side of the receiving vehicle to approach to facilitate the transfer of the product. In some implementations, once the self-driving delivery vehicle is close enough to the receiving vehicle to safely transfer the product, the self-driving delivery vehicle can open one or more compartments that contain the product. Then, a user may reach into the one or more compartments via an open window of the receiving vehicle to acquire the product and carry the product through the open window into the receiving vehicle. In some implementations, the self-driving delivery vehicle can be configured to extend a robotic-arm that is supporting the product toward, or even through, an opening (e.g., a window, a sunroof, an open door, a truck bed, etc.) of the receiving vehicle. Then, once the robotic arm is close enough to the opening of the receiving vehicle for the product to be safely transferred into the receiving vehicle, the robotic arm may be configured to release the product, e.g., by opening a compartment that contains the product. This example is for illustrative purposes and is not to be construed as limiting. It can be appreciated that other mechanisms other than a robotic arm can be used with the techniques disclosed herein. For instance, instead of a robotic arm, a drone such as an unmanned aerial vehicle (UAV) can be deployed from the delivery vehicle to facilitate the transfer of the product. In such embodiments, the drone would be controlled in a manner as described herein, e.g., where a velocity and direction are matched to the receiving vehicle for transfer of the product. A tether or robotic arm on the UAV can then deliver the product as described herein. In some implementations, a computing device can take over the control of all vehicles to coordinate the transfer. Such a computing device can be located in the receiving vehicle, the delivery vehicle or the computing device can be a remote computer in communication with the vehicles via a network.

In some implementations, the self-driving delivery vehicle can select a particular opening, e.g., a window, of the receiving vehicle to deliver the product through based on one or more factors such as local laws and regulations, where an occupant (e.g., a driver of the receiving vehicle or a non-driving passenger) is seated within the receiving vehicle, whether the receiving vehicle is being driven autonomously by an autopilot module or manually driven by a human driver, and/or traffic conditions. In one specific, but non-limiting example, the self-driving delivery vehicle may be configured to deliver the product through a driver's side of the vehicle (e.g., the left-hand side in the United States) if, and only if, the receiving vehicle is being autonomously driven such that any distraction that is caused to an occupant by the delivery will not impact safety. Accordingly, it can be appreciated that depending on a variety of factors, the self-driving delivery vehicle may pull up along either side of the receiving vehicle and furthermore that the compartments and/or robotic arm (where applicable) can be on either side of the self-driving delivery vehicle.

In some implementations, the system can determine where people are seated in the receiving vehicle. Such a determination can be done through an in-car camera with visual recognition or it could be specified during the ordering process. An occupant of the receiving vehicle can also generate data via a computer to communicate a seating position of the occupants. The camera can be in the receiving vehicle or the delivery vehicle. Image data from the camera can be communicated to the system and the image data can be used to determine a side, opening, or area of the receiving vehicle most suitable for delivery. The cameras or other devices, such as weight sensors, can be located at any suitable location, such as a toll plaza, a road inspection checkpoint, etc.

These examples are provided for illustrative purposes and are not to be construed as limiting. Although the delivery of the product is illustrated by one side of the vehicle, it can be appreciated that the delivery vehicle can be in front of the receiving vehicle and pushes objects in through the front of the receiving vehicle. In another example, the delivery vehicle can be at the back of the receiving vehicle and pushes objects in through the back of the receiving vehicle. In yet another example, the delivery vehicle can be flat and approaches the receiving car from underneath.

In some implementations, the receiving vehicle may be identified (e.g., by the system and/or the self-driving delivery vehicle) based on an identifier, a characteristic of the receiving vehicle and/or the client computing device corresponding to the order data. For example, the self-driving delivery vehicle may be configured with one or more computer vision systems that enable the self-driving delivery vehicle to identify the receiving vehicle by license plate number or any other visible characteristic (including characteristics that are invisible to humans but visible to machines such as infrared-paint markings). Additionally or alternatively, the self-driving delivery vehicle may be configured to receive data signals from a client computing device that was used to order the product. Based on these data signals, the self-driving delivery vehicle may identify the receiving vehicle as whichever vehicle (e.g., of numerous vehicles on a public roadway system) is currently carrying the client computing device. For example, a consumer may place a phone call to a service operator or use a smart phone to order the product via an online retailer's mobile application. Then, the self-driving delivery vehicle may enter the predefined rendezvous area while the receiving vehicle is also within the rendezvous area and may communicate with the smart phone to determine which vehicle within the rendezvous area is the receiving vehicle.

As used herein, a vehicle identifier (also referred to herein as a “vehicle ID”) can refer to any unique identifier useful in identifying a particular vehicle. The vehicle ID may be associated with a particular non-autonomous vehicle or autonomous vehicle, and may be provided to the system. In one aspect, the vehicle ID can include a unique identifier such as a Vehicle Identification Number, license plate information, electronic signals transmitted from a vehicle, specific indicia or paint schemes, symbols (e.g., on a roof or upper surface of a vehicle), specific heat signature, and/or specific audio signature. In another aspect, the vehicle ID can include a digital identifier. The digital identifier can include a SIM card ID, ESN, MEID, IMEI, a phone number or other identifier associated with a wireless communication device onboard the vehicle. Such wireless communication devices can include wireless telephony devices, cellular telephones, cellular communications systems, digital communications systems, satellite communications systems, or any other electronic device associated with or onboard the vehicle. Other forms of identifiers are also applicable to some implementations. Heat signatures observed from a camera of the system, such as a camera on the delivery vehicle or a camera at any other location such as a satellite, on a road, toll bridge, etc. As will be described herein, identifiers, which may include an indication of a number of occupants and/or where the occupants are located within a vehicle, can be used to determine a location or the proximity of a receiving vehicle with respect to a rendezvous area and/or a self-driving delivery vehicle.

With respect to identification of the receiving vehicle, it can be appreciated based on numerous examples provided herein that the receiving vehicle can be identified by an active mechanism (e.g., a signal generated by the receiving vehicle). In one example, the receiving vehicle can emit some form of wireless ID or emit another type of identifier. Additionally, or in the alternative, the receiving vehicle can be identified by a passive mechanism (e.g., a camera and/or other sensor of the self-driving delivery vehicle identifying a property, heat signature, and/or an indicia or paint scheme of the receiving vehicle). As used herein, identifying the receiving vehicle by an active mechanism refers generally to identifying the receiving vehicle based on a signal that is actively generated by the receiving vehicle. Exemplary actively generated signals include, but are not limited to, electromagnetic signals such as radio signals, light emission patterns such as headlights and taillights flashed according to a predetermined pattern, GPS data transmitted to the system from the receiving vehicle, and/or any other suitable signal (visual or nonvisual) that the receiving vehicle can generate. Audible sounds can be used to distinguish vehicles from one another, such as an engine sound, distinctive tire noise, etc. In such embodiments, a microphone on the delivery vehicle or another location can generate a signal that can be interpreted by the system. As used herein, the techniques for identifying the receiving vehicle by a passive mechanism generally involves identifying the receiving vehicle based on one or more characteristics of the receiving vehicle. Exemplary characteristics include, but are not limited to, a license plate number, a make and model of the receiving vehicle, the color of the receiving vehicle, a paint scheme of the receiving vehicle, or any other suitable characteristic that can be used to identify the receiving.

In some implementations, the self-driving delivery vehicle may perform multifactor identification of the receiving vehicle wherein at least one factor is a passive identification factor whereas in other factor is an active identification factor. For example, the self-driving delivery vehicle may identify the receiving vehicle based upon a body type and color (e.g., the self-driving delivery vehicle may identify one or more 2017 FORD EXPLORER vehicles that are black in color within the rendezvous area) and may furthermore identify an individual one of these identified vehicles as the receiving vehicle based on a specific signal (e.g., radio signals and/or a predetermined light emission pattern as described elsewhere herein) emitted by the receiving vehicle.

In some implementations, the system may receive preliminary order data that indicates a selection of either the product or a classification associated with the product. For example, the preliminary order data may indicate a selection of the product as a specific value meal option that is offered by a restaurant franchise (e.g., a BIG MAC® Value Meal offered by MCDONALDS®) and which can be obtained at any one of numerous different physical locations for the restaurant franchise. Additionally or alternatively, the preliminary order data may indicate a selection of a value meal option classification under which numerous other value meals are also classified. Then, based on the preliminary order data, the system may determine a plurality of product-acquisition options for scheduling a delivery to the receiving vehicle along the first route. As a more specific but nonlimiting example, a person may use a client computing device (e.g., a smartphone) to obtain directions to the destination-location and to indicate that he or she would like to receive the specific value meal option while traveling en route to the destination-location. Then, according to the techniques described herein, the client computing device may be caused to display the plurality of product-acquisition options to enable the person to select when and where they would like to receive the specific value meal option while traveling en route to the destination-location. In some implementations, the system may determine different individual delivery costs for the plurality of product-acquisition options. As a specific but nonlimiting example, the system may present the person with a first delivery option to rendezvous with the self-driving delivery vehicle at a non-congested city park for a first delivery cost and a second delivery option to rendezvous with the self-driving delivery vehicle while traveling along a busy interstate highway for a second delivery cost. Among other examples, delivery options can include commercial or educational campuses or other predetermined zones. Then, the person can decide between the options based on a balancing of cost vs convenience to the person. In some examples, the delivery cost for a particular product acquisition option may be zero (e.g., the delivery cost could be free delivery).

These and various other features will be apparent from a reading of the following Detailed Description and a review of the associated drawings. This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates an example workflow scenario to facilitate an en route delivery of a product from a self-driving delivery vehicle to a receiving vehicle that is traveling on a roadway system.

FIG. 2 illustrates various details of an area in which a self-driving delivery vehicle delivers a product to the receiving vehicle within the rendezvous area while the receiving vehicle is en route to a destination-location.

FIG. 3 illustrates various details of an area throughout which multiple self-driving delivery vehicles are located and for which an en route delivery scheduling service tracks locations to generate product acquisition options in response to the order data.

FIG. 4A illustrates the self-driving delivery vehicle with the movable compartment extended out of the interior region on a robotic-arm.

FIG. 4B illustrates the self-driving delivery vehicle of FIG. 4A with the movable compartment retracted back into the interior region by the robotic-arm and with a door in a closed position with respect to the interior region.

FIG. 5A illustrates the movable compartment extended out of the self-driving delivery vehicle by the robotic-arm toward the window and with the one or more doors in a closed position to contain the product.

FIG. 5B illustrates the movable compartment extended out of the self-driving delivery vehicle by the robotic-arm toward the window and with the one or more doors in an open position to expose the product.

FIG. 6 is a flow diagram of a process to generate route data for a self-driving delivery vehicle to cause the self-driving delivery vehicle to operate on a roadway system to rendezvous with a receiving vehicle.

FIG. 7 shows an example computer architecture for a computer capable of executing an en route delivery scheduling service as described herein.

### DETAILED DESCRIPTION

The following Detailed Description describes technologies for facilitating an en route product delivery during which a product is transferred from a self-driving delivery vehicle to a receiving vehicle that is navigating along a first route on a roadway system toward a destination-location. Generally described, the self-driving delivery vehicle is dispatched on the roadway system along a second route to carry the product to a predefined rendezvous area along a portion of the second route that is common to the first route. Once the self-driving delivery vehicle is within the vicinity of the receiving vehicle at the rendezvous area, the self-driving delivery vehicle then approaches the receiving vehicle to facilitate a transfer of the product to the receiving vehicle. For example, the self-driving delivery vehicle may be configured to identify the receiving vehicle (e.g., based on an active mechanism and/or a passive mechanism) and then to drive close enough to the receiving vehicle so that the product can be transferred through an open window, or any other suitable opening, of the receiving vehicle. In some configurations, the system can include a mechanism for controlling a window or door of the receiving vehicle. In such embodiments, the system can send control signals to automatically open a window or door through any suitable form of wireless communication. The self-driving delivery vehicle may further be configured to enclose the product within a compartment until the self-driving delivery vehicle is close enough to the receiving vehicle that the product can be safely transferred. In some examples, the compartment is attached to an end of a robotic-arm that may be extended away from the self-driving delivery vehicle towards a window of the receiving vehicle. For example, the self-driving delivery vehicle may deploy the robotic-arm to move the compartment through the window of the self-driving delivery vehicle into an interior region of the receiving vehicle before opening the compartment to enable a person to acquire the product. In another example, the self-driving delivery vehicle may deploy charging cables or hardware for transferring fluid, such as fuel or water. In such embodiments, the delivery vehicle can be used to transfer power, fuel, or any other fluid to the receiving vehicle. In such embodiments, the delivery vehicle can control a robotic arm controlling charging cables or some form of tubing to a suitable connector or opening of the receiving vehicle.

The disclosed systems and techniques thus eliminate the need for people that desire a product while traveling between locations to choose between the first inconvenient option of “picking-up” the product at a source of the product (which increases travel time) or the second inconvenient option of going without the product and continuing on to the destination-location (which leaves a consumer with an unmet desire and/or need for the product). Accordingly, the disclosed systems and techniques represent a substantial advance over conventional delivery services which are limited to delivering products to merely static locations within long “delivery time windows.”

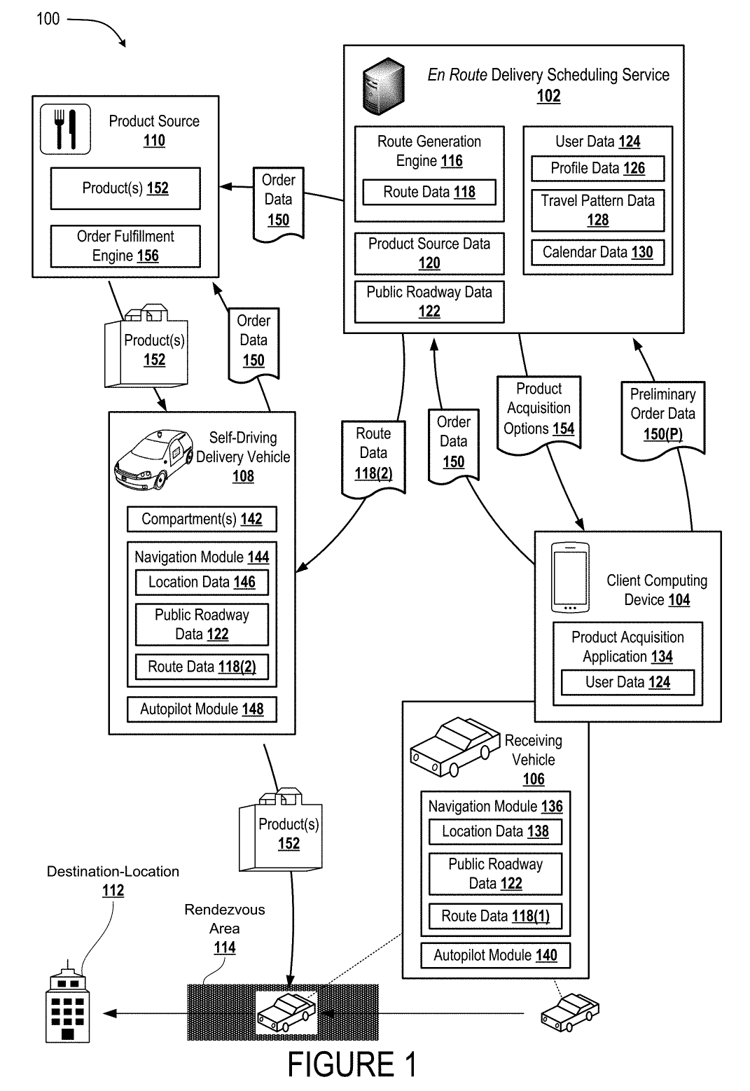

Turning now to FIG. 1, an example workflow scenario is illustrated with respect to a system 100 that facilitates an en route delivery of a product to a receiving vehicle that is traveling on a roadway system towards a destination-location. As used herein, the term “en route delivery” may generally refer to a delivery that occurs at a public location at which a recipient of the delivery will only be temporarily while traveling between locations. An exemplary en route delivery may include, but is not limited to, a delivery of a lunch item to a recipient that is traveling on a roadway system to a destination-location to attend a scheduled meeting. In this way, the recipient can accept delivery of the lunch item while concurrently traveling directly to the destination-location.

As illustrated, the system 100 may include an en route delivery scheduling service 102 that may receive, from a client computing device 104, order data that indicates a selection of a product for delivery to a receiving vehicle 106 that is operating on a roadway system. The system 100 may further include a self-driving delivery vehicle 108 to obtain the product from a product source 110 and to rendezvous with the receiving vehicle 106 on the roadway system. In particular, the self-driving delivery vehicle 108 travels from the product source 110 along the roadway system to a rendezvous area 114 that is specifically tailored to at least partially overlap with a route that the receiving vehicle 106 is navigating on toward the destination-location 112. Ultimately, the product may be transferred from the self-driving delivery vehicle 108 to the receiving vehicle 106 within the rendezvous area 114.

The en route delivery scheduling service 102 may include a route generation engine 116 to generate route data 118 for the self-driving delivery vehicle 108 and/or the receiving vehicle 106. In some implementations, the route generation engine 116 may generate route data 118(2) that indicates a route for the self-driving delivery vehicle 108 to travel along to rendezvous with the receiving vehicle 106 within the rendezvous area 114. The route data 118(2) for the self-driving delivery vehicle 108 may be determined based at least in part on route data 118(1) that indicates a route that the receiving vehicle 106 is expected to travel along toward the destination-location 112. In some implementations, the route generation engine 116 may receive the route data 118(1) from the client computing device 104 and/or the receiving vehicle 106. For example, the route data 118(1) may be included within the order data that indicates the selection of the product for delivery to the receiving vehicle 106. As another example, the en route delivery scheduling service 102 may “ping” the receiving vehicle 106 and/or the client computing device 104 with a request for the route data 118(1) in response to receiving the order data.

In some implementations, the route data 118(2) may further be determined based on product source data 120 that indicates locations for one or more sources of the product. For example, in an instance where the product is a specific value meal option (e.g., a BIG MAC® Value Meal) that is offered by a restaurant franchise (e.g., MCDONALDS®), the product source data 120 may indicate locations for several individual restaurants of the restaurant franchise within the receiving vehicle route area. Accordingly, the route generation engine 116 may analyze the product source data 120 with respect to the route data 118(1) to determine a route that includes a first segment associated with navigating the self-driving delivery vehicle 108 from an initial-location to the product source 110 (e.g., to obtain the product) and a second segment associated with navigating the self-driving delivery vehicle 108 from the product source 110 to the rendezvous area 114. The initial-location or the product source can also be dynamic. For example, the delivery vehicle can include a staff or automated equipment for preparing items, such as food, and the delivery vehicle can travel back and forth along a highway, etc. Such embodiments can be expanded to other service sectors as well.

In some implementations, the route data 118(2) may further be determined based on public roadway data 122 that indicates a map of the roadway system that both the receiving vehicle 106 and the self-driving delivery vehicle 108 drive on to arrive at the rendezvous area 114. For example, the public roadway data 122 may indicate a plurality of different roads, intersection points between the different roads, and/or characteristics of the different roads on the route. Exemplary characteristics of the different roads include, but are not limited to, speed limits, construction activity, real-time traffic conditions, and/or any other characteristics suitable for consideration in determining an optimal route for the self-driving delivery vehicle 108 and or the receiving vehicle 106. In some implementations, the public roadway data 122 may include crowd-sourced information provided by a plurality of members of an online traffic in road information sharing community (e.g., the WAZE® community facilitated by GOOGLE®).

In some implementations, one or both of the route data 118(1) or the route data 118(2) may define one or more course segments that are plotted onto a map of one or more geographical areas. For example, one or both of the receiving vehicle 106 or the self-driving delivery vehicle 108 may travel over one or more segments that are not constrained to roadways but rather are defined by a substantially constant cardinal direction between two locations. As a more specific but non-limiting example, one or both of the receiving vehicle 106 or the self-driving delivery vehicle 108 can travel over an open area of open land (e.g., salt flats, desserts, forests, etc.) upon which the vehicle(s) is capable of freely maneuvering.

In some implementations, receiving vehicles can be prioritized and a route can be modified based on such priorities. For example, the system can schedule multiple deliveries with the same delivery vehicle for different receiving vehicles. The system can determine the order, source and delivery locations, e.g. based on priority of the receiving parties. In one illustrative example, a CEO of a company might have a higher delivery priority than a low-level employee. In yet another example, a University professor might have a higher delivery priority than a student. The priorities can be based on a position, status, title, or any other hierarchy, including a hierarchy based on a subscription fee. Different types of users can be prioritized as desired, e.g., a subscribing user can receive deliveries before a single time paying user or charity user. Priorities can be based on tasks of job function. For example, critical or medically related jobs can receive deliveries before everything else.

In some implementations, the route data 118(2) may further be determined based on user data 124 corresponding to a user associated with the order data such as, for example, an intended recipient of the product. The user data 124 may include profile data 126 that indicates identification information of the user, payment information associated with the user, and/or past purchase information associated with the user. For example, the profile data 126 may indicate a name of the user and credit card information that the user has provided in the past when requesting an en route product delivery. The user data 124 may include travel pattern data 128 that indicates one or more historical travel patterns associated with the user. For example, the travel pattern data 128 may indicate a plurality of past routes that the user has traveled as well as a frequency with which the past routes have been traveled and/or a time of day that the past routes have been traveled. In some implementations, the route generation engine 116 is configured to infer one or more aspects of the route data 118(1) based on the travel pattern data 128. For example, the travel pattern data 128 may indicate that the user regularly travels to the destination-location 112 each Wednesday and Friday between the hours of 11 AM and 12:30 PM. Under these circumstances, when order data is received during or shortly before these hours on a Wednesday or a Friday, the route generation engine 116 may infer that the user will be traveling to the destination-location 112 and may generate the route data 118(2) based on this inference. The user data 124 may include calendar data 130 that indicates one or more calendar events of the user. For example, the calendar data 130 may indicate that the user has a meeting scheduled at the destination-location 112 at 12:30 PM on the current day. Under these circumstances, when order data is received for delivery shortly before 12:30 PM on the current day, the route generation engine 116 may infer that the user will be en route to the destination-location 112 when the delivery is to be performed and may generate the route data 118(2) based on this inference. The system can also use the route data from a phone of an occupant or an in-car GPS system. The system can include the use of a confidence value. If the system is relatively confident of the order, the delivery vehicle can proactively start on a route and cancel it if the order isn't made. This can expedite delivery to regular customers.

In some implementations, the intended recipient of the product may be temporarily associated with the receiving vehicle 106. For example, the intended recipient may be an occupant of a taxi, a bus, a rental vehicle, a rideshare vehicle, and/or any other mode of transportation that an occupant may be temporarily associated with. Temporary associations can be made through any suitable source, such as data that can be generated by tracking the intended recipient's mobile phone, or the user account they sign into to schedule a ride in the receiving vehicle 106. As a more specific but nonlimiting example, the intended recipient may sign into his or her UBER account to schedule transportation to the destination-location. Under these circumstances, the system 100 may be configured to determine one or more identifying characteristics of the receiving vehicle 106 and temporarily associate the receiving vehicle with the intended recipient. In some implementations, the intended recipient of the product may be permanently associated with the receiving vehicle 106. For example, the intended recipient may be an owner of the receiving vehicle 106.

The client computing device 104 may include a product acquisition application 134 to enable the user to generate the order data that indicates the selection of the product for delivery to the receiving vehicle 106. Additionally, order data can be automatically generated based on activity of a computer user. Such activity can include, but is not limited to, order history activity, consumption activity, etc. Recurring orders can be generated and dynamically adjusted based on order history activity, consumption activity, etc. As illustrated, the product acquisition application 134 may have access to and/or generate one or more portions of the user data 124. As further illustrated, the client computing device 104 is shown to overlap with the receiving vehicle 106 to indicate that the client computing device 104 may be within an interior region of the receiving vehicle 106 or may be outside of the receiving vehicle 106 when the order data is generated. In some implementations, the client computing device 104 may be a mobile computing device such as, for example, a laptop computer, a tablet computer, a smart phone, or any other type of mobile computing device. For example, the client computing device 104 may be a smart phone computing device configured with GPS navigation capabilities and configured to send and receive data via a network (e.g., a 4G network, an LTE network, a WLAN network, or any other suitable network). In this example, the product acquisition application 134 may be a mobile shopping application provided by an online retailer (e.g., AMAZON SERVICES, LLC). Thus, the order data may be generated via a mobile computing device that is running the product acquisition application 134 and is being controlled by a user that is riding within the receiving vehicle 106.

The receiving vehicle 106 may include a navigation module 136 to provide real-time navigation instructions to guide the receiving vehicle 106 based on the route data 118(1) toward the destination-location 112. For example, the navigation module 136 may be configured with one or more components (e.g., a GPS component, non-limiting examples may include Glonass, Galileo, Compass) for determining location data 138 that indicates one or more real-time locations of the receiving vehicle 106. The navigation module 136 may then analyze the location data 138 with respect to the public roadway data 122 and/or the route data 118(1) to generate the real-time navigation instructions for guiding the receiving vehicle toward the destination-location 112. In some implementations, the receiving vehicle 106 may further include an autopilot module 140 to enable the receiving vehicle 106 to be at least partially self-driving. Exemplary capabilities of the autopilot module 140 include, but are not limited to, speed management to maintain a speed of the receiving vehicle 106 with respect to a speed limit, object tracking to identify obstacles and perform avoidance maneuvers such as turning and/or braking, lane following to keep the receiving vehicle 106 within lanes marked on a public roadway, traffic signal monitoring to identify road signs and/or traffic lights and react accordingly, and/or any other capability suitable for an autopilot module for inclusion within an automobile.

The self-driving delivery vehicle 108 may include a compartment 142 that is configured to at least partially enclose the product while the self-driving delivery vehicle 108 transports the product from the product source 110 to the rendezvous area 114. In some implementations, the self-driving delivery vehicle 108 may be configured to selectively open the compartment 142 to enable the product to be loaded into and/or removed from the compartment 142. For example, the self-driving delivery vehicle 108 may open the compartment 142 upon arrival at the product source 110 and, based on a determination that the product has been loaded into the compartment 142, the self-driving delivery vehicle 108 may close the compartment 142 to transport the product to the rendezvous area 114. Ultimately, the self-driving delivery vehicle 108 may re-open the compartment 142 to facilitate a transfer of the product from the self-driving delivery vehicle 108 to the receiving vehicle 106. The delivery vehicle 108 can determine that the product has been loaded into the compartment 142 by the use of a number of mechanisms. For instance, a user within the receiving vehicle or even a remote user (e.g., an employee at the source) can trigger the compartment 142 to close. The same mechanisms can be utilized to open the compartment 142.

The self-driving delivery vehicle 108 may further include a navigation module 144 to provide real-time navigation instructions to guide the self-driving delivery vehicle 108 based on the route data 118(2) toward the rendezvous area 114 to rendezvous with the receiving vehicle 106 that is en route to the destination-location 112. For example, the navigation module 144 may be configured with one or more components (e.g., a GPS component) for determining location data 146 that indicates one or more real-time locations of the self-driving delivery vehicle 108. The navigation module 144 may analyze the location data 146 with respect to the public roadway data 122 and/or the route data 118(2) to generate the real-time navigation instructions which are ultimately provided to an autopilot module 148 that enables the self-driving delivery vehicle 108 to be fully autonomous (e.g., capable of operating safely on a public roadway without human input) and/or at least partially autonomous. The autopilot module 148 may include, but is not limited to, those features discussed with respect to the autopilot module 140.

In some implementations, the system 100 may be configured to facilitate establishment of a communications link between the autopilot module 140, of the receiving vehicle 106, and the autopilot module 148 of the self-driving delivery vehicle 108. Then, in some examples, the receiving vehicle 106 may transmit maneuver data indicating one or more impending vehicle maneuvers that the receiving vehicle 106 is about to perform. The self-driving delivery vehicle 108 may receive the maneuver data and simultaneously perform the one or more impending vehicle maneuvers alongside the receiving vehicle 106. The maneuvers to be performed by the delivery vehicle might have to vary slightly to keep the same relative position, e.g. in curves. For instance, the delivery vehicle may have to drive slower or faster depending on whether it is closer to the center of the circle on which circumference the turn is being driven. Additionally or alternatively, the receiving vehicle 106 may transmit obstacle data indicating one or more obstacles that are identified by the receiving vehicle (e.g., slowing traffic ahead, a swerving vehicle, an animal, or any other obstacle identifiable by the receiving vehicle) to inform the self-driving delivery vehicle 108 of obstacles that the self-driving delivery vehicle 108 is unable to identify or has yet to identify. Accordingly, based on the maneuver data and/or the obstacle data, the autopilot module 140 is able to communicate with the autopilot module 148 (and vice versa) to enable the self-driving delivery vehicle 108 to maintain a predetermined relative position with respect to the receiving vehicle 106. In some examples, the self-driving delivery vehicle 108 may determine that the receiving vehicle is equipped with autopilot functionality that is not currently active. In such embodiments, an instruction (e.g., an audible instruction, a visible instruction, etc.) may be transmitted to the receiving vehicle to instruct a human operator to activate the autopilot so that an in-motion delivery can be performed.

In some cases, the delivery transaction might have to be aborted. In such scenarios, the robotic arm holding the product can be retracted. The delivery vehicle can try to reposition by the use of one or more maneuvers to reattempt a delivery. In some cases, the robotic arm can be detached to allow the robotic arm to be jettisoned to avoid an accident. In such embodiments, the robotic arm can be controlled by any computing device to detach in response to any signal generated by the computing system. For instance, when two vehicles reach a threshold probability of a collision or when a person may be too close to the robotic arm, the system can cause the robotic arm to detach. In some cases, one or more vehicles might have to be sacrificed to save bystanders and passengers present in any vehicle in or near the rendezvous area. Special navigation maneuvers or safety features can be installed for such scenarios.

With respect to the workflow scenario of FIG. 1 (i.e., the transfers of data and/or movement of physical objects associated with implementing the techniques described herein), the en route delivery scheduling service 102 is shown to receive order data 150 from the product acquisition application 134 that is running on the client computing device 104. The order data 150 indicates a selection of the product 152, which can be obtained from the product source 110, for delivery to the receiving vehicle 106 while en route to the destination-location 112. In some implementations, the order data 150 includes the route data 118(1) to inform the en route delivery scheduling service 102 of a first route on the roadway system that the receiving vehicle 106 will travel toward the destination-location 112. The route data 118(1) may further indicate a first travel-schedule of the receiving vehicle 106 with respect to the first route. Specifically, the first travel-schedule includes information that indicates a timeline with which the receiving vehicle 106 is expected to progress along the first route. For example, the first travel-schedule may indicate a plurality of points along the first route and corresponding times at which the receiving vehicle 106 is expected to reach individual ones of the plurality points. In some implementations, the order data 150 may be devoid of the route data 118(1) such that the en route delivery scheduling service 102 may be configured to obtain the route data 118(1) from alternate sources, infer the route data 118(1), or even generate the route data 118(1) and provide it to the receiving vehicle and/or client computing device 104. For example, the en route delivery scheduling service 102 may infer the route data 118(1) based on one or more aspects of the user data 124. Additionally or alternatively, the en route delivery scheduling service 102 may obtain the route data 118(1) from the navigation module 136.

In some implementations, the order data 150 may correspond to a selection of an individual product-acquisition option of a plurality of product acquisition options 154 that are provided by the en route delivery scheduling service 102. For example, as illustrated, product acquisition application 134 is shown to provide preliminary order data 150(P) to the en route delivery scheduling service 102. The preliminary order data 150(P) may indicate one or both of a selection of the product 152 and/or a classification associated with the product 152. For example, the preliminary order data may indicate a selection of the product as a specific value meal option that is offered by a restaurant franchise (e.g., a BIG MAC® Value Meal offered by MCDONALDS®) and can be obtained at any one of numerous different physical locations for the restaurant franchise. Additionally or alternatively, the preliminary order data may indicate a selection of a value meal option classification under which numerous other specific value meals are also classified from one or more different restaurants. Stated plainly, the preliminary order data 150(P) may indicate that the user is interested only in receiving the specific value meal option or that the user is interested in receiving a value meal option in general.

In response to receiving the preliminary order data 150(P), the en route delivery scheduling service 102 may determine a plurality of product-acquisition options 154 based on one or both of the product source data 120 and the route data 118(1). Individual ones of the plurality of product-acquisition options 154 may indicate a particular source from which a product can be obtained, details regarding the product (e.g., a cost of the product, a product-type, nutrition information associated with the product (where applicable), or any other suitable details). As a more specific but nonlimiting example, the preliminary order data 150(P) may indicate that the user is interested in obtaining a meal (e.g., a classification associated with the product 152) while traveling in the receiving vehicle 106 to the destination-location 112. In this example, the plurality of product-acquisition options 154 may include a first product acquisition option that the user can select to order a hamburger and fries from a first product source and a second product acquisition option that the user can select to order a turkey sandwich and an apple from a second product source. The product-acquisition options 154 may further indicate where along the first route each suggested product can be delivered to the receiving vehicle 106 and/or a cost of delivering each suggested product to the receiving vehicle 106.

As further illustrated, the product-acquisition options 154 are provided to the client computing device 104 which, ultimately, communicates details associated with the product acquisition options 154 to the user. For example, the client computing device 104 may include a display configured to visually communicate details associated with the product acquisition options 154. Additionally or alternatively, the client computing device 104 may be configured to audibly communicate details associated with the product acquisition options 154. In such implementations, the client computing device 104 further enables the user to select one or more individual ones of the product acquisition options 154 to generate the order data 150 (e.g., by selecting a user interface element corresponding to a particular option). Thus, it can be appreciated that in some implementations, the user may provide the en route delivery scheduling service 102 with preliminary order data 150(P) that indicates an interest in ordering the product 152 but does not yet actually place an order for the product. In some configurations, the system 100 can also automatically select one or more sources from the product acquisition options 154 based on the data described herein. In such embodiments, the system 100 can automatically generate order data 150 and, as described below, generate route data 118 for navigating to and/or from the location of the selected sources. Then, based on the preliminary order data 150(P), the en route delivery scheduling service 102 may determine and provide back to the user the plurality of product acquisition options 154 from which the user can select to order one or more products.

In response to receiving the order data 150, the en route delivery scheduling service 102 may generate the route data 118(2) and, ultimately, may provide the route data 118(2) to the self-driving delivery vehicle 108 to dispatch the self-driving delivery vehicle 108 along the second route. As described above, the second route may include a first segment associated with navigating the self-driving delivery vehicle 108 from an initial-location to the product source 110 (e.g., to obtain the product) and a second segment associated with navigating the self-driving delivery vehicle 108 from the product source 110 to the rendezvous area 114 to facilitate transfer of the product from the self-driving delivery vehicle 108 to the receiving vehicle 106. Accordingly, dispatching the self-driving delivery vehicle 108 may include first dispatching the self-driving delivery vehicle 108 to the product source 110 and then subsequently dispatching the self-driving delivery vehicle 108 to the rendezvous area 114. In some configurations, a vehicle can be dispatched by the generation of dispatch data that is configured to cause a delivery vehicle to navigate from a first point, e.g., an initial-location, to a second point, e.g., a source-location.

Some scenarios may involve multiple product sources. In such scenarios, the delivery vehicle 108 can navigate from the initial-location to a number of sources. This may be necessary when certain sources have specialized or limited inventory and order may include multiple products or multiple components of a product. In such scenarios, the route data can be configured to navigate the delivery vehicle 108 between the sources and to the rendezvous area 114.

In some configurations, certain delivery vehicles can be assigned to particular geographical areas. In such configurations, vehicles covering different areas can hand off a product between delivery vehicles until the product reaches the rendezvous area 114. Thus, the route data can be configured to navigate a number of delivery vehicles 108 to transport a product from one or more sources to the rendezvous area 114. The route data and other control mechanisms can also coordinate the delivery between the delivery vehicles, e.g., by use of the robotic arm or other mechanisms for transferring product from one vehicle to another.

In some implementations, the en route delivery scheduling service 102 transmits at least some of the order data 150 to the product source 110 to prompt the product source 110 to begin preparing the product 152. For example, in an instance in which the product 152 is the specific value meal option, the en route delivery scheduling service 102 may transmit the order data 150 to the selected physical location of a restaurant franchise to prompt preparing of the specific value meal option. In some implementations, the product source 110 may operate an order fulfillment engine 156 to manage orders received from the en route delivery scheduling service 102. For example, the order fulfillment engine 156 may receive the order data 150 and determine when the product source 110 (and/or staff thereof) should begin preparation of the product 152. As a more specific but nonlimiting example, a user may transmit the order data 150 to the en route delivery scheduling service 102 which relays this order data 150 to the product source 110 far in advance (e.g., three hours before, one day before, etc.) of when the en route delivery is to be performed within the rendezvous area 114. In this example, the order fulfillment engine 156 may submit details corresponding to the order data 150 into an order queue of the product source 110 at an appropriate time to ensure that the product 152 is freshly prepared when the delivery is performed within the rendezvous area 114.

As illustrated, in some implementations, the self-driving delivery vehicle 108 may be configured to provide one or more aspects of the order data 150 to the product source 110. For example, the self-driving delivery vehicle 108 may be caused to navigate through a drive-through line at the product source 110 and to communicate aspects of the product order 150 to the product source 110 through a drive-through ordering system. As a more specific but nonlimiting example, the self-driving delivery vehicle 108 may be configured with one or more loudspeakers that enable aspects of the product order 150 to be audibly communicated to the product source 110. Additionally or alternatively, the self-driving delivery vehicle 108 may be configured to establish a communication link with the product source 110 and wirelessly communicate aspects of the product order 150, e.g. without communicating details directly to human staff at the product source 110.

In the illustrated implementation, after the self-driving delivery vehicle 108 arrives at the product source 110, the product 152 may be transferred from the product source 110 to the self-driving delivery vehicle 108. For example, one or more staff members of the product source 110 may manually place the product within the compartment 142. Once the product 152 is received from the product source 110, the self-driving delivery vehicle 108 may proceed to navigate along a second segment of the second route to rendezvous with the receiving vehicle 106 within the rendezvous area 114. Ultimately, the system 100 causes the self-driving delivery vehicle 108 to approach the receiving vehicle 106 within the rendezvous area 114 to facilitate a transfer of the product 152 from the self-driving delivery vehicle 108 to the receiving vehicle 106 and/or an occupant thereof. For example, the self-driving delivery vehicle 108 may pull up alongside the receiving vehicle 106 while the receiving vehicle is driving down an interstate highway and, ultimately, extend a robotic-arm (or other product delivery mechanism) supporting the compartment 142 through an open window of the receiving vehicle 106 before opening the compartment 142 to “drop” the product 152 into the open window of the receiving vehicle 106.

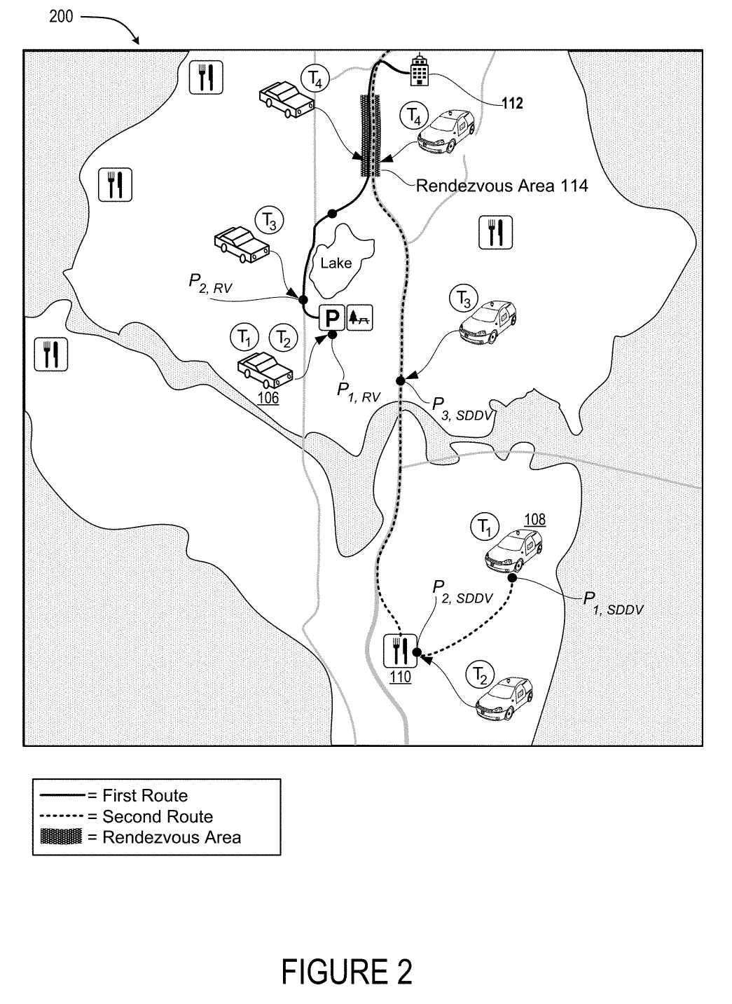

Turning now to FIG. 2, various details are illustrated of an area 200 in which a self-driving delivery vehicle 108 delivers a product to a receiving vehicle 106 within a rendezvous area 114 while the receiving vehicle 106 is en route to a destination-location 112. As illustrated, the receiving vehicle 106 travels along a first route that begins at an initial-location P_{1, RV} and ends at the destination location 112. Illustrated along the first route is a second-location P_{2, RV} that the receiving vehicle 106 reaches at time T₃, and the rendezvous area 114 that the receiving vehicle 106 reaches at time T₄. As further illustrated, the self-driving delivery vehicle 108 travels along a second route that begins at an initial-location P_{1, SDDV} and extends at least to the rendezvous area 114. Illustrated along the second route is a second-location P_{2, SDDV} that the self-driving delivery vehicle 108 reaches at time T₂, a third-location P_{3, SDDV} that the self-driving delivery vehicle 108 reaches at time T₃, and the rendezvous area 114 that the self-driving delivery vehicle 108 reaches at time T₄.

At time T₁, order data 150 is generated via the client computing device 104 and is transmitted to the en route delivery scheduling service 102. The order data 150 indicates a selection of the product 152 and further indicates a first travel-schedule indicating one or more times with which the user expects to travel in the receiving vehicle 106 along the first route. For example, the order data 150 may indicate that the user expects to remain at the initial-location P RV until departing at time T₂ along the first route to the destination-location 112. Based on the order data 150 and the location data 146 indicating that the self-driving delivery vehicle 108 is at the initial-location P_{1, SDDV}, the en route delivery scheduling service 102 determines the route data 118(2) and based thereon, dispatches the self-driving delivery vehicle 108 to the product source 110 which is located at the second-location P_{2, SDDV}. In the illustrated example, by the time the receiving vehicle 106 departs from the initial-location P_{1, RV}, the self-driving delivery vehicle 108 has already been dispatched to and reached the product source 110. Thus, it can be appreciated that a user may schedule an en route delivery for a travel segment that the user has yet to begin.

At time T₃, the receiving vehicle 106 and the self-driving delivery vehicle 108 are both traveling along their respective routes towards the rendezvous area 114 where they will then become within the vicinity of one another.

At time T₄, the receiving vehicle 106 and the self-driving delivery vehicle 108 are both within the rendezvous area 114 where the self-driving delivery vehicle 108 searches for and ultimately identifies the receiving vehicle 106. As described above, the self-driving delivery vehicle 108 can identify the receiving vehicle 106 based on active mechanisms and/or passive mechanisms. Furthermore, any specific examples provided herein are for illustrative purposes only and are not to be construed as limiting or exhaustive. Numerous other techniques for identifying the receiving vehicle 106 are contemplated and are within the scope of the present disclosure.

In some implementations, the self-driving delivery vehicle 108 may identify the receiving vehicle 106 based on one or more readily identifiable characteristics of the receiving vehicle 106. For example, the self-driving delivery vehicle 108 may be configured with one or more computer vision systems to identify the receiving vehicle 106 by a license plate number (or any other passive vehicle identifier for that matter). Additionally or alternatively, the self-driving delivery vehicle 108 may receive actively generated signals from the client computing device 104 to enable the receiving vehicle 106 to be identified. For example, the client computing device 104 may be a smart phone that is equipped with one or more GPS components to generate location data indicating a real-time location of the client computing device 104. Then, the client computing device 104 may actively transmit this location data to the self-driving delivery vehicle 108 to enable the self-driving delivery vehicle 108 to locate and identify the receiving vehicle 106 within the rendezvous area 114. Additionally or alternatively, the self-driving delivery vehicle 108 may identify the receiving vehicle 106 based on one or more actively generated visual signals. For example, the receiving vehicle 106 may be caused to emit a series of quick emissions of light (e.g., from headlights and/or taillights and/or hazard lights) that the self-driving delivery vehicle 108 is able to recognize to identify the receiving vehicle 106. As a more specific but nonlimiting example, as the self-driving delivery vehicle 108 enters the rendezvous area 114, one or more components of the system 100 (e.g., the self-driving delivery vehicle 108 and/or the en route delivery scheduling service 102) may transmit instructions to the receiving vehicle 106 to cause the receiving vehicle 106 to emit a predetermined light flashing pattern. For example, the system 100 may cause the receiving vehicle 106 to flash its brake lights ten times with each flash being 0.25 seconds long with 0.5 seconds in between each flash. Then, the self-driving delivery vehicle 108 may identify the receiving vehicle 106 as a specific vehicle among many other vehicles within the rendezvous area 114 that is emitting the predetermined light flashing pattern. For example, the self-driving delivery vehicle 108 may have six total vehicles within its viewable area (e.g., viewable by computer vision cameras of the self-driving delivery vehicle 108) with only the receiving vehicle 106 emitting the predetermined flashing light pattern. In this way, the self-driving delivery vehicle 108 is able to identify the receiving vehicle 106 even in the absence of permanently visible identifying indicia (e.g. a license plate, VIN, IR paint markings, etc.).

Once the receiving vehicle 106 is identified, the self-driving delivery vehicle 108 approaches the receiving vehicle 106 to achieve a distance between the vehicles that is close enough to facilitate a transfer of the product 152 from the self-driving delivery vehicle 108 to the receiving vehicle 106. For example, the self-driving delivery vehicle 108 may pull up alongside the receiving vehicle 106 while the receiving vehicle 106 is traveling along an interstate highway. The self-driving delivery vehicle may closely monitor a velocity and/or side-to-side steering movements of the receiving vehicle to safely achieve and maintain a close distance between the two vehicles. In some implementations, once the self-driving delivery vehicle 108 is within a predetermined distance from the receiving vehicle 106 (e.g., 6 inches, 12 inches, 18 inches, etc.), the self-driving delivery vehicle 108 may open the compartment 142 that contains the product 152 to allow a recipient that is riding within the receiving vehicle 106 to open a window to acquire the product 152 from the compartment 142. After the product 152 is successfully transferred from the self-driving delivery vehicle 108 to the receiving vehicle 106, the receiving vehicle 106 may exit the rendezvous area 114 and continue along the first route towards the destination-location 112 while the self-driving delivery vehicle 108 exits the rendezvous area 114 and continues along the second route and/or receives subsequent route data 118(2) indicating another second route to fulfill another order.

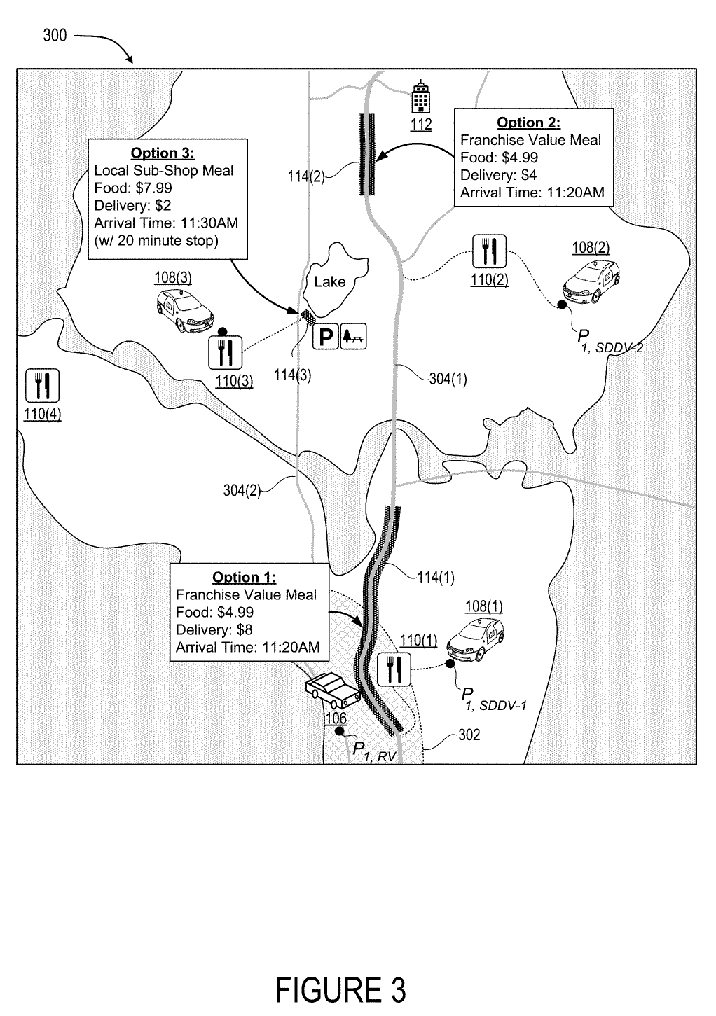

Turning now to FIG. 3, various details are illustrated of an area 300 throughout which multiple self-driving delivery vehicles 108 are located and for which the en route delivery scheduling service 102 tracks locations of and generates product acquisition options with respect to. In particular, the area 300 includes first through third self-driving delivery vehicles labeled 108(1) through 108(3), respectively. In the illustrated example, preliminary order data 150(P) is generated via the client computing device 104 and is transmitted to the en route delivery scheduling service 102 while the receiving vehicle 106 is located at the initial-location P_{1, RV}. The preliminary order data 150(P) indicates that the user will be shortly departing from the initial-location P_{1, RV} to the destination-location 112 and would like to receive an en route food delivery. In some implementations, the preliminary order data 150(P) may also indicate a latest arrival time that the user can arrive at the destination-location 112. For example, the user may have a meeting scheduled at 11:45 AM at the destination-location 112 such that the preliminary order data 150(P) indicates a latest arrival time of 11:45 AM. In some implementations, the en route delivery scheduling service 102 may access the calendar data 130 to identify a calendar event and, based thereon, determine the latest arrival time.

Based on the preliminary order data 150(P), the en route delivery scheduling service 102 determines a plurality of product-acquisition options 154 and, ultimately, provides these product-acquisition options 154 to the client computing device 104. The user may use the client computing device 104 to compare the plurality of product-acquisition options 154 and, ultimately, to select an individual product-acquisition. Based on the user selection, the client computing device 104 transmits order data 150 to the en route delivery scheduling service 102 which then prompts dispatching of a particular one of the self-driving delivery vehicles that correspond to the selected product-acquisition option. In the illustrated example, the en route delivery scheduling service 102 has determined three different product-acquisition options each having unique characteristics as compared to the other product-acquisition options.

The first product-acquisition option is for the user to receive a franchise value meal (e.g., a BIG MAC® Value Meal offered by MCDONALDS®) within a first rendezvous area 114(1) for a total cost of $12.99 and an estimated arrival time at the destination-location 112 of 11:20 AM. In some implementations, the total cost of any particular product-acquisition option includes a delivery cost in addition to a product cost. For example, the first product-acquisition option includes a delivery cost of $8 and a product cost of $4.99. In some implementations, the delivery cost for any individual product-acquisition option may be based on factors such as a distance of a self-driving delivery vehicle from a product source, traffic conditions that the self-driving delivery vehicle is likely to encounter, whether other orders exist such that the self-driving delivery vehicle can fulfill several deliveries within or near a rendezvous area, etc. Other charges can be applied, such as, but not limited to, time of day charges, toll charges, long distance charges, rural area charges, and charges for extreme weather conditions, etc. For example, in the illustrated example the first self-driving delivery vehicle 108(1) that corresponds to the first product-acquisition option would be required to enter a heavily congested metropolitan area 302 and the en route delivery scheduling service 102 may consider this factor in determining the relatively high delivery cost of the first product-acquisition option as compared to the other two product-acquisition options. The second product-acquisition option is similar to the first product-acquisition option except that the second self-driving delivery vehicle 108(2) is able to pick up the same franchise value meal from a different product source 110(2) (i.e., a different franchise location) than the first self-driving delivery vehicle 108(1) and, ultimately, deliver the same franchise value meal to the receiving vehicle 106 without having to enter the metropolitan area 302.

In some implementations, the en route delivery scheduling service 102 is configured to determine one or more product acquisition options having alternate routes and transmit at least some of the route data 118(1) to the client computing device 104 within the product-acquisition options 154. For example, as illustrated, both the first and second product-acquisition options have rendezvous areas (labeled 114(1) and 114(2), respectively) along a first public roadway 304(1) whereas the third product-acquisition option has a rendezvous area 114(3) at a public parking lot (indicated by the “P” symbol) of a public park (indicated by the picnic table symbol) that is located off a second public roadway 304(2). As illustrated, the third product-acquisition option includes a rendezvous with the third self-driving delivery vehicle 108(3) at the public parking lot to accept a delivery of a local sub shop meal that is offered by a third product source 110(3). The service can also favor routes that yield more income or save resources. Multiple routes can be ranked by the system and individual routes can be selected based on one or more factors.

In some implementations, the en route delivery scheduling service 102 is configured to determine whether the user can receive a stationary delivery (e.g., by pulling into a parking lot or pulling onto the shoulder of a road) of the product while en route to the destination-location 112 without arriving later than the predetermined latest arrival time (e.g., a time indicated in the preliminary order data 150(P) and/or determined based on the calendar data 130). For example, in FIG. 3 the en route delivery scheduling service 102 has determined that the third product-acquisition option would permit a 20-minute stop at the public park during which the user could accept delivery of and even consume the local sub shop meal and still arrive at the destination-location prior to the predetermined latest arrival time. Thus, in some implementations the en route delivery scheduling service 102 may be configured to identify and suggest product-acquisition options that permit users to take “breaks” from their professional responsibilities without negatively impacting their punctuality and/or productivity.

In various implementations, the en route delivery scheduling service 102 is configured to select one or more individual product sources 110 to obtain the product 152 based on a location of the individual product sources 110 with respect to the first route and/or the second route. For example, as illustrated in FIG. 3 a fourth product source 110(4) also exists from which the product 152 could potentially be obtained and delivered to the receiving vehicle 106. As further illustrated, the en route delivery scheduling service 102 has provided a product-acquisition option 154 that corresponds to the fourth product source 110(4). As shown, the fourth product source 110(4) is located relatively farther away from the first route options (e.g., along the first public roadway 304(1) and the second public roadway 304(2)). Therefore, in order to source the product 152 from the fourth product source 110(4), a self-driving delivery vehicle 108 would have to travel a great distance away from the potential first route such that this option would be inefficient as compared to the other three product-acquisition options discussed in relation to FIG. 3. Thus, in various implementations, the techniques described herein include selecting individual self-driving delivery vehicles 108 in conjunction with individual product sources 110 based on a relative location of the individual self-driving vehicles 108 with respect to the individual product sources 110 and/or a relative location of the individual product sources 110 with respect to the first route(s) that the receiving vehicle 106 is expected to travel.

In various implementations, the en route delivery scheduling service 102 is configured to select one or more individual self-driving delivery vehicles 108 to obtain the product 152 based upon specific capabilities of the individual self-driving delivery vehicles 108. For example, the en route delivery scheduling service 102 may identify a current energy reserve level (e.g., a current battery level and/or fuel level) and/or a current mileage range (e.g., a distance that can be traveled before depleting energy reserves) of the individual self-driving delivery vehicles 108. Then, individual self-driving delivery vehicles 108 may be selected to fulfill various orders based upon their specific capabilities. For example, an individual self-driving delivery vehicle 108 that has only a current mileage range of twenty-five miles may not be selected to fulfill an order that will require a self-driving delivery vehicle 108 to travel fifty miles. Individual self-driving delivery vehicles can also be selected, and routes can be determined, based on other factors. For instance, the system 100 can determine when on-road charging devices are present. The location of the charging devices can be used to determine the capabilities of a vehicle and also be used to determine a route to guide the vehicle to the charging station.

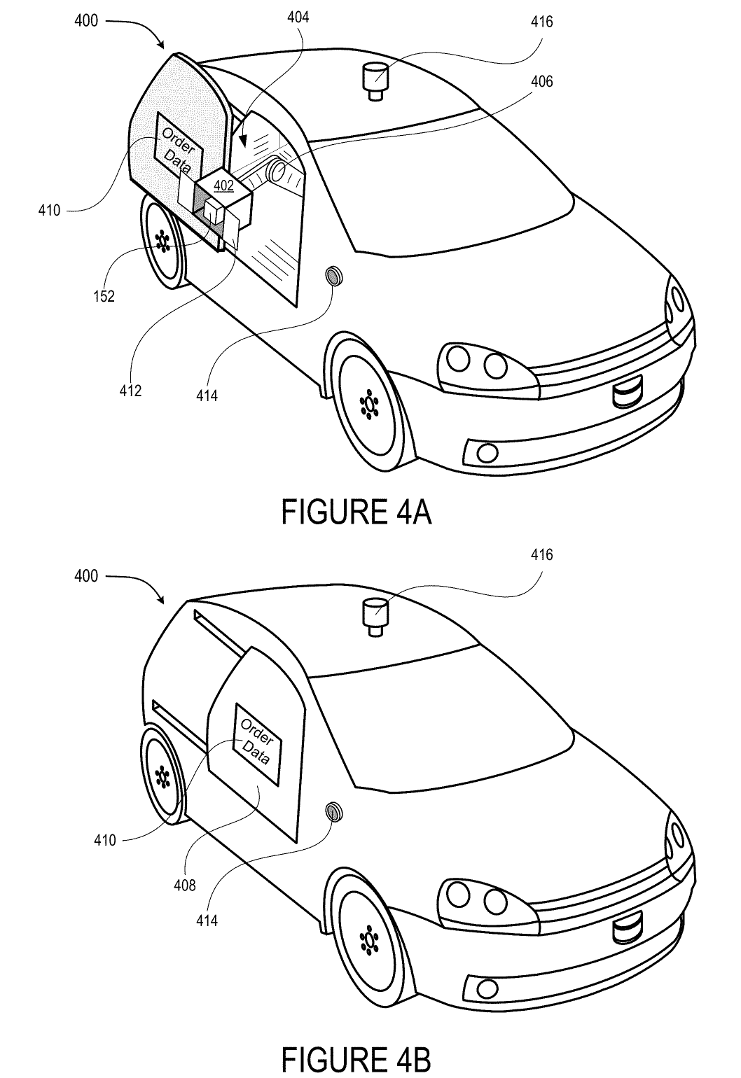

Turning now to FIGS. 4A and 4B (collectively referred to herein as FIG. 4), a self-driving delivery vehicle 400 is illustrated that includes a movable compartment 402 configured to be retracted into and extended out of an interior region 404 of the self-driving delivery vehicle 400. In particular, FIG. 4A illustrates the self-driving delivery vehicle 400 with the movable compartment 402 extended out of the interior region 404 on a robotic-arm 406. Furthermore, FIG. 4B illustrates the self-driving delivery vehicle 400 with the movable compartment 402 retracted back into the interior region 404 by the robotic-arm 406 and with a door 408 in a closed position with respect to the interior region 404. Although this example involves a robotic-arm 406, it can be appreciated that the delivery vehicle 400 may be equipped with any type of compartment for delivering a product. In other examples, the compartment may have a controlled door for exposing the product within a predetermined period.

During implementation of the techniques described herein, the self-driving delivery vehicle 400 may be dispatched to a product source 110 to obtain the product 152. In some implementations, the self-driving delivery vehicle 400 may further include one or more input and/or output devices that enable the self-driving delivery vehicle 400 to communicate aspects of the order data 150 to the product source. For example, as illustrated in FIG. 4B, the self-driving delivery vehicle 400 includes a display 410 on the door 408 to visually render details corresponding to the order data 150 to the product source and/or the recipient of the order. Accordingly, the self-driving delivery vehicle 400 may inform the product source or an employee thereof which specific product is to be loaded into the movable compartment 402. Once the self-driving delivery vehicle 400 has determined that the product 152 has been loaded into the movable compartment 402, the movable compartment 402 may be closed and retracted by the robotic-arm 406 back into the interior region 404 of the self-driving delivery vehicle 400. For example, the movable compartment 402 may include one or more doors 412 that are configured to swing and/or slide to selectively open and close the movable compartment 402.

In some implementations, the self-driving delivery vehicle 400 includes one or more sensors 414 that are positioned to monitor an object (e.g., the receiving vehicle) that is off to a particular side of the self-driving delivery vehicle 400 that the movable compartment 402 is configured to extend out of. For example, the self-driving delivery vehicle 400 may include one or more LiDAR sensors and/or computer vision cameras positioned to monitor a relative movement and/or position of the receiving vehicle with respect to the self-driving delivery vehicle 400 when the self-driving delivery vehicle 400 approaches the receiving vehicle within the rendezvous area to deliver the product 152.

In some implementations, the self-driving delivery vehicle 400 includes one or more signal devices 416 to inform a recipient that the self-driving delivery vehicle 400 is present at the rendezvous area. In the illustrated example, the signaling device 416 is a flashing light that is mounted to a roof. The self-driving delivery vehicle 400 may turn on the signaling device 416 to enable a recipient of the product to easily identify the self-driving delivery vehicle 400. For example, in a scenario in which the rendezvous area is a public parking lot, the self-driving delivery vehicle 400 may arrive at the public parking lot prior to the receiving vehicle. In such an instance, the self-driving delivery vehicle 400 may monitor the location of the receiving vehicle and based on a determination that the receiving vehicle is just now entering the public parking lot the self-driving delivery vehicle 400 may activate the signaling device 416 to enable the self-driving delivery vehicle 400 to be readily distinguished from one or more other vehicles within the public parking lot. In an alternate scenario in which the self-driving delivery vehicle arrives at the public parking lot after the receiving vehicle, the self-driving delivery vehicle 400 may activate the signaling device 416 as the receiving vehicle enters the parking lot to direct the recipient's attention to it. Additionally or alternatively, a text message or other wireless alert may be transmitted to the client computing device 104 as the self-driving delivery vehicle 400 enters the rendezvous area.

As described elsewhere herein, in some implementations the self-driving delivery vehicle 400 may transfer the product 152 into the receiving vehicle while both vehicles are in motion on a public roadway. For example, the self-driving delivery vehicle 400 may pull up alongside the receiving vehicle and, while maintaining a relative position to the receiving vehicle, may open the door 408 and may deploy the robotic-arm 406 to extend the movable compartment 402 towards or even into an interior region of the receiving vehicle. The techniques described herein, however, are not limited to such implementations. Rather, the transfer of the product 152 from the self-driving delivery vehicle 400 into the receiving vehicle may occur while both vehicles are in motion, or alternatively while the receiving vehicle and/or the self-driving delivery vehicle 400 is stopped. For example, in some implementations the self-driving delivery vehicle 400 may enter the rendezvous area and park. Then, the receiving vehicle may approach the self-driving delivery vehicle 400 to facilitate transfer of the product 152 to the receiving vehicle. In some implementations, the receiving vehicle may stop adjacent to, on the side of, in front of, behind, or within a predetermined distance from the self-driving delivery vehicle 400, or vice versa. As a more specific but nonlimiting example, the receiving vehicle may arrive at a rendezvous area within a public parking lot several minutes after the self-driving delivery vehicle 400 has arrived and parked in a parking stall of the public parking lot. The receiving vehicle may park within a different stall that is within the predetermined distance from the self-driving delivery vehicle 400 (e.g., within fifteen feet, thirty feet, one-hundred feet, etc.) and the recipient may exit the receiving vehicle and walk over to the self-driving delivery vehicle 400. The recipient may then provide identifying information to cause the self-driving delivery vehicle 400 to expose and/or open the movable compartment 402.

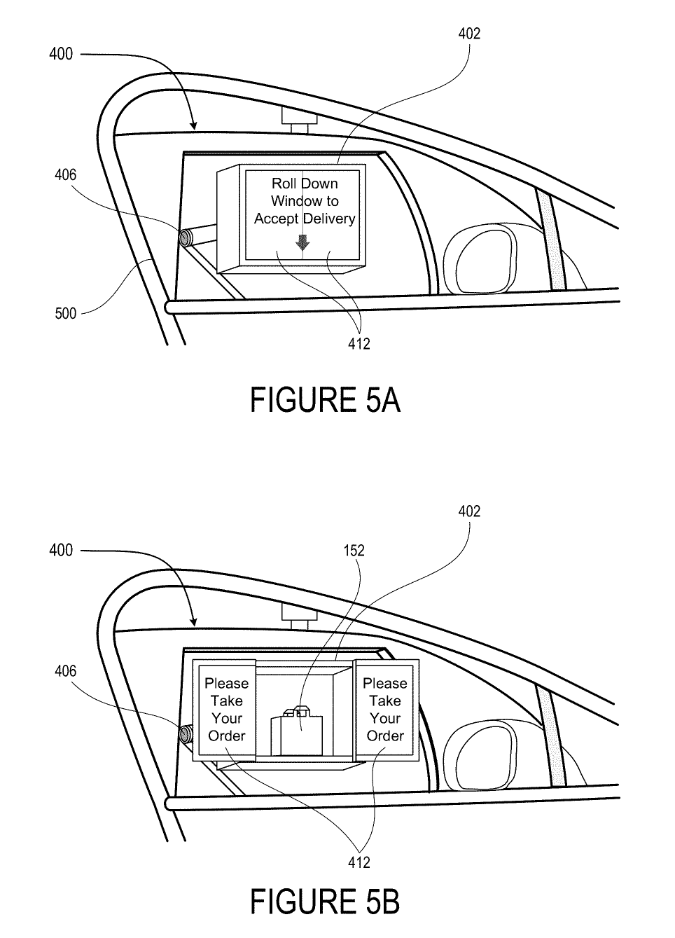

Turning now to FIGS. 5A and 5B (collectively referred to herein as FIG. 5), a partial view of the self-driving delivery vehicle 400 is shown with the movable compartment 402 extended towards a window 500 of the receiving vehicle. In particular, FIG. 5A illustrates the movable compartment 402 extended out of the self-driving delivery vehicle 400 by the robotic-arm 406 toward the window 500 and with the one or more doors 412 in a closed position to contain the product 152. In FIG. 5B the one or more doors 412 are shown in an open position to expose the product 152 and, thus, to facilitate a transfer of the product 152 from the self-driving delivery vehicle 400 into the receiving vehicle. In some implementations, the one or more doors 412 are maintained in the closed position until the movable compartment 402 is extended by the robotic-arm 406 within a predetermined distance from the window 500. For example, the one or more doors 412 may be maintained in the closed position until the movable compartment 402 is extended to within twelve inches from the window 500, six inches from the window 500, or until the movable compartment 402 passes through the window 500 into an interior region of the receiving vehicle 106.

In some implementations, the movable compartment 402 includes one or more user interfaces that enable the self-driving delivery vehicle 400 to communicate with and to receive user input from a recipient of the order. For example, as illustrated, the one or more doors 412 are shown to display information to the user to facilitate the transfer of the product 152. In particular, in FIG. 5A the one or more doors 412 are shown in the closed position while displaying the message “Roll Down Window to Accept Delivery.” Accordingly, a recipient of the order that is riding within the receiving vehicle may react to this message by rolling his or her window down to accept the delivery. In FIG. 5B the one or more doors 412 are shown in the open position while displaying the message “Please Take Your Order” to instruct the recipient to reach into the movable compartment 402 and acquire the product 152.

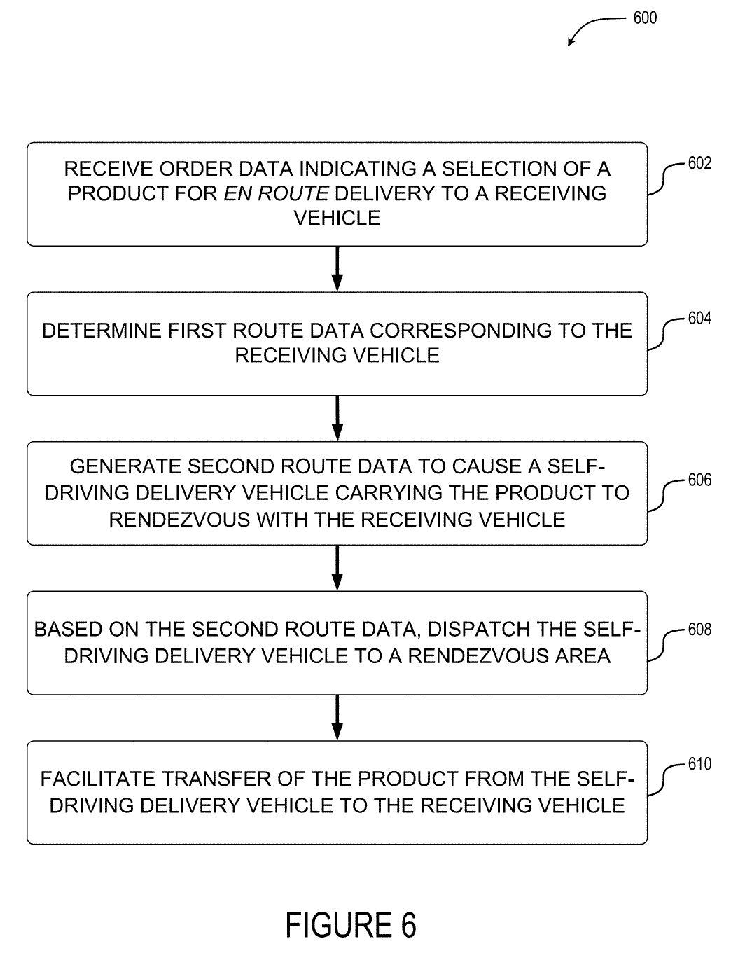

Turning now to FIG. 6, a flow diagram is illustrated of a process 600 to generate route data for a self-driving delivery vehicle to cause the self-driving delivery vehicle to navigate along a roadway system to rendezvous with a receiving vehicle that is operating on the roadway system. The process 600 is described with reference to FIGS. 1-5B. The process 600 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform or implement particular functions. The order in which operations are described is not intended to be construed as a limitation, and any number of the described blocks can be combined in any order and/or in parallel to implement the process. Other processes described throughout this disclosure shall be interpreted accordingly.

At block 602, a system may receive order data that indicates a selection of a product for delivery to a receiving vehicle that is en route to a destination-location. Exemplary receiving vehicles include, but are not limited to, road-based vehicles such as cars and/or trucks that are configured to operate on a roadway system, track-based vehicles such as trains that are configured to operate on a railway system, outdoor water-based vehicles such as fishing boats and/or cargo vessels that are configured to navigate through waterways. As used herein, the term “roadway system” refers generally to any system of interconnected roads that are configured for vehicle travel such a delivery vehicle and a receiving vehicle may travel along one or more of the interconnected roads. Exemplary roadway systems include, but are not limited to, systems of privately funded roadways (e.g., road systems and business campuses), and publicly funded roadways such as, for example, highways, interstates, arterials, and residential streets. Accordingly, the delivery may be performed for a receiving vehicle that is en route on a publicly funded highway to cross a city and/or a privately funded campus roadway (e.g., a roadway on GOOGLE'S business campus in Mountain View, Calif., and/or MICROSOFT'S business campus in Redmond, Wash.). As used herein, the term “railway system” refers generally to any system of interconnected tracks or rails along which one or more vehicles are configured to operate.

At block 604, the system may determine first route data corresponding to the receiving vehicle. In some implementations, the first route data may be included, in whole or in part, with the order data. For example, determining the first route data at block 604 may comprise parsing the first route data from the order data received at block 602. In some implementations, the first route data may be generated by the system based on the order data received at block 604, user data 124 received from a client computing device 104, and/or directly from a navigation module 136 corresponding to the receiving vehicle and/or a client computing device. In some implementations, the first route data indicates a first route that the receiving vehicle is expected to navigate along to arrive at a destination-location. Stated alternatively, the first route data may indicate an expected path (e.g., along a series of predetermined roads) that the receiving vehicle will traverse to arrive at the destination-location. In some implementations, the first route data further indicates a first travel-schedule that defines time-based expectations of when the receiving vehicle will reach various points along the first route.

In some implementations, determining the first route data may include determining route-deviation data associated with causing the receiving vehicle to deviate from a direct route between an initial-location of the receiving vehicle and the destination-location. For example, the system may determine a plurality of rendezvous areas along a plurality of different routes that the receiving vehicle could potentially take from the initial-location to the destination-location. Then, the system may transmit data to enable a consumer to select between a plurality of different product acquisition options. For example, the consumer may be provided with a first option to receive the en route delivery on a most direct route between the initial-location and the destination-location for a first delivery cost in addition to a second option to receive the en route delivery on a slightly less direct route for a second delivery cost that is less than the first cost. The route deviation data may indicate how deviation from the most direct route will impact an estimated time of arrival at the destination-location as well as varying delivery costs associated with receiving delivery at different rendezvous areas along the different routes.

At block 606, the system may generate second route data to cause the self-driving delivery vehicle to rendezvous with the receiving vehicle along the first route while the self-driving delivery vehicle is carrying the product. Generating the second route data may be responsive to receiving the order data. In some implementations, the second route data may indicate a second route for the self-driving delivery vehicle to take to the rendezvous area and/or a second travel-schedule for the self-driving delivery vehicle to travel along the second route. Since the receiving vehicle is expected to be traveling along the first route during the en route delivery, it can be appreciated that the second travel-schedule may at least partially define the rendezvous area along a portion of the second route that is common to the first route. Stated alternatively, the rendezvous area may be defined by the combination of the first travel-schedule which indicates when the receiving vehicle will be at various points along the first route and the second travel-schedule which indicates when the self-driving delivery vehicle will be at various points along the second route.

In some implementations, the second route data may be generated based on one or more aspects of the user data 124. For example, the second route and/or the second travel-schedule may be determined based on a status of a consumer corresponding to the order data 150 such as, for example, whether the consumer is a preferred member associated with the en route delivery scheduling service 102. As another example, the second route data and/or the second travel-schedule may be determined based on a rank of the consumer corresponding to the order data within an organizational and/or governmental hierarchy (e.g., the second route data may be generated to prioritize deliveries to high-ranking individuals). As another example, the second route data and or the second travel-schedule may be determined based upon a payment system to enable consumers to bid for prioritized delivery (e.g., consumers that are willing to pay more for delivery may have their deliveries prioritized). In some implementations, the second route data may be generated to limit potential rendezvous areas based upon a consumer's willingness to pay for delivery. For example, a consumer that is willing to pay a relatively high amount for delivery may be provided with the option to select the rendezvous area within the congested metropolitan area 302 whereas another consumer that is willing to pay a relatively low amount for delivery may be provided with options to select rendezvous areas on the outside of the congested metropolitan area 302.

In some implementations, a particular rendezvous area may be selected based upon an environmental impact of the receiving vehicle. For example, a fully electric receiving vehicle may be permitted to rendezvous within a public park whereas a heavy diesel receiving vehicle may be restricted from rendezvous within the public park.

At block 608, the self-driving delivery vehicle may be dispatched from an initial-location along the second route to the rendezvous area so that the self-driving delivery vehicle will be present within the rendezvous area when the receiving vehicle is expected to be present within the rendezvous area. As described elsewhere herein, dispatching the self-driving delivery vehicle from the initial-location to the rendezvous area may include first dispatching the self-driving delivery vehicle along a first segment of the second route to a product source and then subsequently dispatching the self-driving delivery vehicle along a second segment of the second route to the rendezvous area. In some implementations, however, the self-driving delivery vehicle may be dispatched from the initial-location directly to the rendezvous area to deliver the product. For example, the self-driving delivery vehicle may be preloaded with the product (or a plurality of different products for that matter) and may be ready to be dispatched directly to the receiving vehicle upon receiving the order. As a more specific but nonlimiting example, the self-driving delivery vehicle may be preloaded with a variety of different refreshments (e.g., sodas, candy bars, healthy snacks, bottled waters, sandwiches, etc.) and/or convenience items (e.g., Toiletries, Chapstick, deodorant, batteries, phone chargers, dress shirts, etc.), and/or any other type of item suitable for an en route delivery. In one example, the self-driving delivery vehicle is configured to physically alter the product from a first material-form to a second material-form by performing one or more operations to one or more components of the product. In some implementations, the self-driving delivery vehicle may be configured to perform an assembly operation to physically combine one or more components of the product. As a more specific but nonlimiting example, the self-driving delivery vehicle may be configured with automated equipment or staff to assemble a sandwich (i.e., the product) out of the bread component and a sandwich meat component. In some implementations, the self-driving delivery vehicle may be configured to perform a heating or cooling operation to transfer heat (either in a positive or negative sense for respectively heating or cooling) into one or more components of the product. As a more specific but nonlimiting example, the self-driving delivery vehicle may be configured to apply heat to a raw hamburger component to transform the raw hamburger component into a fully cooked hamburger (i.e. the product).

In some configurations, the delivery vehicle can also be manually driven by a diver that is directed by direction data. For instance, the driver can be provided with computer-based instructions that navigate through one or more routes described herein. The instructions can be displayed on a display device or printed on a medium. In some configurations, the instructions can be communicated over a communications system such as peer-to-peer system or a mobile phone system, etc. Thus, the term self-driving vehicle can also mean a vehicle that is controlled by a driver following directions generated by one or more components of the system 100.

At block 610, the self-driving delivery vehicle may be caused to approach the receiving vehicle within the rendezvous area to facilitate a transfer of the product from the self-driving delivery vehicle to the receiving vehicle. For example, the self-driving delivery vehicle may pull up directly alongside the receiving vehicle and extend a robotic-arm that supports the product within a compartment close to or even into the receiving vehicle. Then, upon the compartment being opened, an occupant of the receiving vehicle may reach into the compartment to obtain the product and carry the product into the interior region of the receiving vehicle.

In some examples, the self-driving delivery vehicle may monitor movements of the receiving vehicle to determine whether the receiving vehicle is currently under the control of an autopilot module. For example, a human operator is likely to exhibit small and frequent course deviations even while traveling within a single lane on a straight stretch of the highway, whereas an autopilot module will maintain a straighter track on the highway. Accordingly, the self-driving delivery vehicle may infer the current autonomy level of the receiving vehicle based on movements of the receiving vehicle that are monitored by at least one sensor. In some examples, the self-driving delivery vehicle may determine that the receiving vehicle is either not equipped with an autopilot module and/or is not currently being controlled by the autopilot module. Then, the self-driving delivery vehicle may transmit an instruction to the receiving vehicle and/or client computing device that causes the receiving vehicle to change from a first operational state (e.g., driving at a first velocity, being driven manually, etc.) to a second operational state (e.g., driving at a second velocity that is less than the first velocity (e.g., slowing from sixty miles per hour on a lane on an interstate highway to zero miles per hour on an off ramp and/or shoulder). As a more specific but nonlimiting example, the self-driving delivery vehicle may approach the receiving vehicle within the rendezvous area and may monitor movements of the receiving vehicle using the at least one sensor. Then, based on a determination that the receiving vehicle is not under the control of an autopilot module, the self-driving delivery vehicle may transmit an instruction to the receiving vehicle that causes a speaker of the receiving vehicle to audibly inform a driver (and/or causes a graphical user interface to display the instruction to the driver) of the receiving vehicle that his or her order has arrived and furthermore to pull to the side of the road to initiate the transfer protocol. In some implementations, the self-driving delivery vehicle may determine whether a driver has reasonably complied with the instructions provided (e.g., based on whether the driver pulled off at the next available opportunity). Then, if the driver fails to reasonably comply with the instructions, the delivery may be aborted and/or the drivers account may be charged a fee. In some examples, the self-driving delivery vehicle may determine that the receiving vehicle is equipped with autopilot that is not currently active. In such embodiments, an instruction (e.g., an audible instruction, a visible instruction, etc.) may be transmitted to the receiving vehicle to instruct a human operator to activate the autopilot so that an in-motion delivery can be performed.

In some examples, the self-driving delivery vehicle may be configured to monitor a location of the receiving vehicle while the receiving vehicle is en route to the destination-location or even once the receiving vehicle has already reached and has parked at its destination-location. Then, the self-driving delivery vehicle may approach the receiving vehicle, transmit an instruction that causes the receiving vehicle to open an window and/or a sunroof, transfer the product through the window and/or sunroof into the receiving vehicle, transmit a second instruction that causes the receiving vehicle to close the window and/or sunroof, and then drive away. It can be appreciated that according to these techniques the self-driving delivery vehicle may be configured to deliver a product to a receiving vehicle regardless of whether an occupant is present within the receiving vehicle. For example, an intended recipient may be driving across his or her home state while the self-driving delivery vehicle is carrying the product towards the receiving vehicle. Then, the intended recipient may stop for a restroom break and/or to have a meal and, therefore, may park and leave the receiving vehicle. Under these circumstances, the self-driving delivery vehicle may be configured to approach the receiving vehicle even in the absence of the intended recipient and completely fulfill the order prior to the intended recipient returning to the receiving vehicle.

In some implementations, the self-driving delivery vehicle may include an interior shopping region that a consumer may enter while en route to a destination-location. For example, the self-driving delivery vehicle may be a large truck having an interior region that is stocked with items commonly found in a convenience store. In such an instance, the order data may indicate a general interest in browsing through the interior region of the self-driving delivery vehicle. In response to the order data, the self-driving delivery vehicle may rendezvous with the receiving vehicle and, ultimately, dock with the receiving vehicle while in motion to enable an occupant of the receiving vehicle to enter the interior region of the self-driving delivery vehicle and browse through the “mobile” convenience store. For example, the self-driving delivery vehicle may extend one or more mechanical coupling components out to grasp on to the receiving vehicle and, ultimately, to securely maintain a relative position of the receiving vehicle with respect to the self-driving delivery vehicle. Then, an occupant of the receiving vehicle may be transferred (e.g., by walking across a ramp and/or passing through a tunnel) into the interior region of the self-driving delivery vehicle. Ultimately, once the occupant is finished shopping he or she may be transferred back into the receiving vehicle. Then, the self-driving delivery vehicle may undock from the receiving vehicle and the two vehicles may depart from one another.

In some implementations, the receiving vehicle 106 may serve to at least partially deliver the product 152 to another location and/or to another receiving vehicle 106. For example, upon receiving delivery of the product 152 at the receiving vehicle 106, the receiving vehicle 106 may continue along the first route into a second rendezvous area at which a second self-driving delivery vehicle 106 again performs a rendezvous with the receiving vehicle 106. During the rendezvous, the two vehicles may perform a coordination protocol, e.g., a handshake, to verify identities, coordinate speed and direction, and/or confirm any other conditions described herein. Then, the product 152 may be transferred from the receiving vehicle into the second self-driving delivery vehicle 108 which then continues on with the product 152 to fulfill a corresponding order. In various implementations, an owner and/or operator of the receiving vehicle 106 may be compensated based on various factors such as, for example, a size of the product, and importance of the product, a deviation from his or her most direct route, a distance that the product is carried, and/or any other relevant factor.

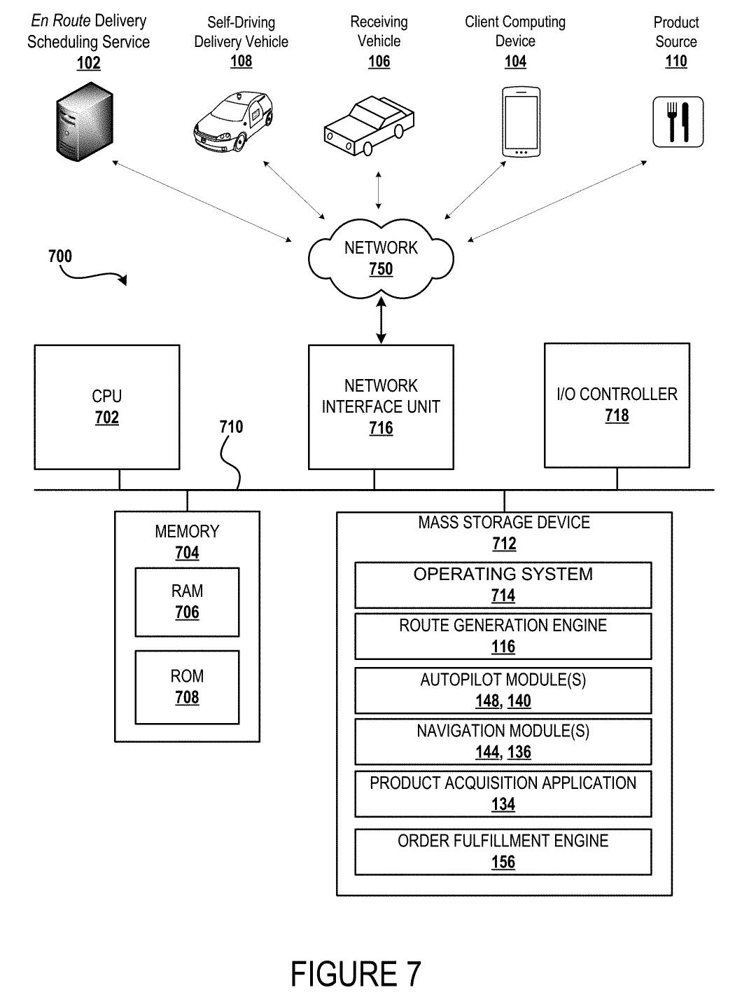

FIG. 7 shows additional details of an example computer architecture 700 for a computer capable of executing the en route delivery scheduling service 102, and/or any program components thereof as described herein. Thus, the computer architecture 700 illustrated in FIG. 7 illustrates an architecture for a server computer, or network of server computers, or any other types of computing devices suitable for implementing the functionality described herein. The computer architecture 700 may be utilized to execute any aspects of the software components presented herein.

The computer architecture 700 illustrated in FIG. 7 includes a central processing unit 702 (“CPU”), a system memory 704, including a random-access memory 706 (“RAM”) and a read-only memory (“ROM”) 708, and a system bus 710 that couples the memory 704 to the CPU 702. A basic input/output system containing the basic routines that help to transfer information between elements within the computer architecture 700, such as during startup, is stored in the ROM 708. The computer architecture 700 further includes a mass storage device 712 for storing an operating system 714, other data, and one or more application programs. According to further embodiments, the operating system 714 may comprise the UNIX, ANDROID, WINDOWS PHONE, MacOS, or iOS operating systems, available from their respective manufacturers. The mass storage device 712 may further include one or more of the route generation engine 116, one or both of the autopilot modules 148 and 140, one or both of the navigation modules 144 and 136, the product acquisition application 134, and/or the order fulfillment engine 156.

The mass storage device 712 is connected to the CPU 702 through a mass storage controller (not shown) connected to the bus 710. The mass storage device 712 and its associated computer-readable media provide non-volatile storage for the computer architecture 700. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computer architecture 700.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 700. For purposes of the claims, the phrase “computer storage medium,” “computer-readable storage medium” and variations thereof, does not include waves, signals, and/or other transitory and/or intangible communication media, per se.

According to various techniques, the computer architecture 700 may operate in a networked environment using logical connections to remote computers through a network 750 and/or another network (not shown). The computer architecture 700 may connect to the network 750 through a network interface unit 716 connected to the bus 710. It should be appreciated that the network interface unit 716 also may be utilized to connect to other types of networks and remote computer systems. The computer architecture 700 also may include an input/output controller 718 for receiving and processing input from a number of other devices, including a keyboard, mouse, or electronic stylus (not shown in FIG. 7). Similarly, the input/output controller 718 may provide output to a display screen, a printer, or other type of output device (also not shown in FIG. 7). It should also be appreciated that via a connection to the network 750 through a network interface unit 716, the computing architecture may enable the en route delivery scheduling service 102 to communicate with one or more of the self-driving delivery vehicle 108, the receiving vehicle 106, the client computing device 104, and/or the product source 110.

It should be appreciated that the software components described herein may, when loaded into the CPU 702 and executed, transform the CPU 702 and the overall computer architecture 700 from a general-purpose computing system into a special-purpose computing system customized to facilitate the functionality presented herein. The CPU 702 may be constructed from any number of transistors or other discrete circuit elements, which may individually or collectively assume any number of states. More specifically, the CPU 702 may operate as a finite-state machine, in response to executable instructions contained within the software modules disclosed herein. These computer-executable instructions may transform the CPU 702 by specifying how the CPU 702 transitions between states, thereby transforming the transistors or other discrete hardware elements constituting the CPU 702.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 700 in order to store and execute the software components presented herein. It also should be appreciated that the computer architecture 700 may include other types of computing devices, including hand-held computers, embedded computer systems, personal digital assistants, and other types of computing devices known to those skilled in the art. It is also contemplated that the computer architecture 700 may not include all the components shown in FIG. 7, may include other components that are not explicitly shown in FIG. 7, or may utilize an architecture completely different than that shown in FIG. 7.

Although the examples disclosed herein utilize graphical user interfaces for display screens, it can be appreciated that data described herein can be communicated to a user by any type of communication. For instance, a voice command can be generated over a speaker system, projection devices can be used, etc. It can be appreciated that any type of data can be communicated to a user using any suitable delivery mechanism.

### Example Clauses

The disclosure presented herein may be considered in view of the following clauses.

Example Clause A, a system for scheduling an en route product delivery, the system comprising: at least one processor; and at least one computer storage media storing instructions that are executable by the at least one processor to: obtain order data indicating a selection of a product for delivery to a receiving vehicle; determine first route data that at least partially indicates a first route, on a roadway system, for the receiving vehicle to travel to a destination-location; select a source of the product based at least in part on a source-location, of the source, with respect to the first route on the roadway system; generate second route data that indicates a second route, on the roadway system, for a self-driving delivery vehicle, wherein the second route includes a first segment associated with navigating the self-driving delivery vehicle from an initial-location to the source-location, and wherein the second route includes a second segment associated with navigating the self-driving delivery vehicle from the source-location to a rendezvous area at a portion of the second route that is common to the first route; generate dispatch data causing a dispatch of the self-driving delivery vehicle from the initial-location to the source-location; and in response to the product being loaded into the self-driving delivery vehicle, cause the self-driving delivery vehicle to navigate from the source-location to the rendezvous area to facilitate transfer of the product from the self-driving delivery vehicle to the receiving vehicle.

Example Clause B, the system of Example Clause A, wherein the instructions are further executable by the at least one processor to cause the self-driving delivery vehicle to: open one or more compartments while located at the source-location to facilitate loading of the product into the one or more compartments; and close the one or more compartments in response to the product being loaded into the one or more compartments.

Example Clause C, the system of any one of Example Clauses A through B, wherein the instructions are further executable by the at least one processor to cause communication of at least some of the order data to the source while located at the source-location.

Example Clause D, the system of any one of Example Clauses A through C, wherein the instructions are further executable by the at least one processor to: verify a presence of the receiving vehicle at the rendezvous area; and in response to the verifying the presence, cause the self-driving delivery vehicle to open one or more compartments to facilitate the transfer of the product from the self-driving delivery vehicle to the receiving vehicle.

Example Clause E, the system of any one of Example Clauses A through D, wherein the instructions are further executable by the at least one processor to: determine route-deviation data associated with causing the receiving vehicle to deviate, to one or more available rendezvous areas, from a direct route between an initial-location of the receiving vehicle to the destination-location, wherein the route-deviation data indicates individual delivery costs associated with the one or more available rendezvous areas; and cause at least one of the receiving vehicle or a client computing device corresponding to the order data to communicate the route-deviation data to enable a user to select the rendezvous area based on the individual delivery costs.

Example Clause F, the system of any one of Example Clauses A through E, wherein the instructions are further executable by the at least one processor to: receive location data that indicates one or more substantially real-time locations of the receiving vehicle along the first route; and control, based on the location data, a velocity of the self-driving delivery vehicle to cause the self-driving delivery vehicle to approach the receiving vehicle within the rendezvous area on the roadway system.

Example Clause G, the system of any one of Example Clauses A through F, wherein at least one of the first route or the second route is determined based on traffic data that indicates traffic conditions corresponding to one or more individual public roads on the roadway system.

While Example Clauses A through G are described above with respect to a system, it is understood in the context of this document that the subject matter of Example Clauses A through G can also be implemented by a device, via a computer-implemented method, and/or via computer-readable storage media.

Example Clause H, a method, comprising: obtaining order data indicating a selection of a product for delivery to a receiving vehicle that is operating on a roadway system; determining first route data that indicates a first route on the roadway system and a first travel-schedule, of the receiving vehicle, with respect to the first route on the roadway system; generating, in response to the receiving of the order data, second route data that indicates a second route on the roadway system and a second travel-schedule, for a self-driving delivery vehicle, with respect to the second route on the roadway system, wherein the second travel-schedule at least partially defines a rendezvous area along a portion of the second route that is common to the first route; dispatching the self-driving delivery vehicle from a source of the product along the second route to the rendezvous area; and causing the self-driving delivery vehicle to approach the receiving vehicle within the rendezvous area to transfer the product from the self-driving delivery vehicle to the receiving vehicle.

Example Clause I, the method of Example Clause H, further comprising: determining source-location data corresponding to a plurality of available sources for the product; and selecting, based on the source-location data and the first route data, the source of the product from the plurality of available sources for the product.

Example Clause J, the method of any one of Example Clauses H through I, further comprising identifying the receiving vehicle within the rendezvous area based on a characteristic of at least one of the receiving vehicle or a client computing device corresponding to the order data.

Example Clause K, the method of any one of Example Clauses H through J, further comprising: in response to the identifying of the receiving vehicle, causing the self-driving delivery vehicle to extend a robotic-arm that is supporting the product toward a window of the receiving vehicle; and causing the self-driving delivery vehicle to retract the robotic-arm when the product has been transferred into the receiving vehicle.

Example Clause L, the method of any one of Example Clauses H through K, further comprising: receiving preliminary order data indicating at least some of the first route data and at least one of the selection of the product or a classification associated with the product; determining, based on the preliminary order data, a plurality of product-acquisition options for scheduling a delivery to the receiving vehicle along the first route, wherein the selection corresponds to an individual product-acquisition option of the plurality of product-acquisition options.

Example Clause M, the method of any one of Example Clauses H through L, wherein the determining of the first route data includes receiving at least one of calendar data defining an appointment location, the first route data from a navigation module of at least one of the receiving vehicle, or a client computing device corresponding to the order data and generating the determining of the first route data based on at least one of calendar data defining an appointment location, the first route data from a navigation module of at least one of the receiving vehicle, or a client computing device corresponding to the order data.

Example Clause N, the method of Example Clause M, further comprising receiving, from the navigation module, location data that indicates one or more substantially real-time locations of the receiving vehicle along the first route, wherein the causing of the self-driving delivery vehicle to approach the receiving vehicle is based at least in part on the one or more substantially real-time locations of the receiving vehicle.

Example Clause O, the method of any one of Example Clauses H through N, wherein determining the first route data includes: determining route-deviation data associated with deviating from a direct route to one or more available rendezvous areas from an initial location of the receiving vehicle and a destination location of the receiving vehicle; and causing at least one of the receiving vehicle or a client computing device corresponding to the order data to communicate at least some of the route-deviation data to enable a user to select the rendezvous area from the one or more available rendezvous areas.

While Example Clauses H through O are described above with respect to a method, it is understood in the context of this document that the subject matter of Example Clauses H through O can also be implemented by a device, by a system, and/or via computer-readable storage media.

Example Clause P, a system comprising: at least one processor; and at least one computer storage media storing instructions that are executable by the at least one processor to: obtain order data indicating a selection of a product for delivery by a self-driving delivery vehicle to a receiving vehicle that is operating on a roadway system; determine first route data that indicates a first travel-schedule that the receiving vehicle is expected to travel along a first route on the roadway system; in response to receiving the order data, generate second route data that indicates a second travel-schedule for the self-driving delivery vehicle to travel along a second route on the roadway system, wherein the second travel-schedule at least partially defines a rendezvous area along a portion of the second route that is common to the first route; dispatch the self-driving delivery vehicle from an initial-location along the second route to the rendezvous area; and cause the self-driving delivery vehicle to approach the receiving vehicle within the rendezvous area and to open a compartment containing the product to facilitate a transfer of the product from the self-driving delivery vehicle to the receiving vehicle.

Example Clause Q, the system of Example Clause P, wherein the instructions are further executable by the at least one processor to: cause the self-driving delivery vehicle to maintain a relative position of the self-driving delivery vehicle with respect to the receiving vehicle while the receiving vehicle is traveling along the first route; and causing the self-driving delivery vehicle to extend a robotic-arm that is supporting the compartment containing the product toward the receiving vehicle while maintaining the relative position with respect to the receiving vehicle.

Example Clause R, the system of any one of Example Clauses P through Q, wherein the instructions are further executable by the at least one processor to establish a communications link between a first autopilot module of the receiving vehicle and a second autopilot module of the self-driving delivery vehicle, wherein the communications link facilitates a transfer of at least one of maneuver data and/or obstacle data between the first autopilot module and the second autopilot module to enable the self-driving delivery vehicle to maintain a relative position with respect to the receiving vehicle.

Example Clause S, the system of any one of Example Clauses P through R, wherein the first route data includes at least travel pattern data associated with at least one of the receiving vehicle and/or a client computing device corresponding to the order data.

Example Clause T, the system of any one of Example Clauses P through S, wherein the self-driving delivery vehicle is configured to physically alter the product from a first material-form to a second material-form by at least one of performing at least one of a heating operation to transfer heat into one or more components of the product or an assembly operation to physically combine one or more components of the product.

While Example Clauses P through T are described above with respect to a system, it is understood in the context of this document that the subject matter of Example Clauses P through T can also be implemented by a device, via a computer-implemented method, and/or via computer-readable storage media.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A system for scheduling an en route product delivery, the system comprising:
at least one processor; and
at least one computer storage media storing instructions that are executable by the at least one processor to:
obtain order data indicating a selection of a product for delivery to a receiving vehicle;
determine first route data that at least partially indicates a first route, on a roadway system, for the receiving vehicle to travel to a destination-location;
select a source of the product based at least in part on a source-location, of the source, with respect to the first route on the roadway system;
generate second route data that indicates a second route, on the roadway system, for a self-driving delivery vehicle, wherein the second route includes a first segment associated with navigating the self-driving delivery vehicle from an initial-location to the source-location, and wherein the second route includes a second segment associated with navigating the self-driving delivery vehicle from the source-location to a rendezvous area at a portion of the second route that is common to the first route;
generate dispatch data causing a dispatch of the self-driving delivery vehicle from the initial-location to the source-location; and
in response to the product being loaded into the self-driving delivery vehicle, cause the self-driving delivery vehicle to navigate from the source-location to the rendezvous area to facilitate transfer of the product from the self-driving delivery vehicle to the receiving vehicle.

2. The system of claim 1, wherein the instructions are further executable by the at least one processor to cause the self-driving delivery vehicle to:
open one or more compartments while located at the source-location to facilitate loading of the product into the one or more compartments; and
close the one or more compartments in response to the product being loaded into the one or more compartments.

3. The system of claim 1, wherein the instructions are further executable by the at least one processor to cause communication of at least some of the order data to the source while located at the source-location.

4. The system of claim 1, wherein the instructions are further executable by the at least one processor to:
verify a presence of the receiving vehicle at the rendezvous area; and
in response to the verifying the presence, cause the self-driving delivery vehicle to open one or more compartments to facilitate the transfer of the product from the self-driving delivery vehicle to the receiving vehicle.

5. The system of claim 1, wherein the instructions are further executable by the at least one processor to:
determine route-deviation data associated with causing the receiving vehicle to deviate, to one or more available rendezvous areas, from a direct route between an initial-location of the receiving vehicle to the destination-location, wherein the route-deviation data indicates individual delivery costs associated with the one or more available rendezvous areas; and
cause at least one of the receiving vehicle or a client computing device corresponding to the order data to communicate the route-deviation data to enable a user to select the rendezvous area based on the individual delivery costs.

6. The system of claim 1, wherein the instructions are further executable by the at least one processor to:
receive location data that indicates one or more substantially real-time locations of the receiving vehicle along the first route; and
control, based on the location data, a velocity of the self-driving delivery vehicle to cause the self-driving delivery vehicle to approach the receiving vehicle within the rendezvous area on the roadway system.

7. The system of claim 1, wherein at least one of the first route or the second route is determined based on traffic data that indicates traffic conditions corresponding to one or more individual public roads on the roadway system.

8. A method comprising:
obtain order data indicating a selection of a product for delivery to a receiving vehicle that is operating on a roadway system;
determining first route data that indicates a first route on the roadway system and a first travel-schedule, of the receiving vehicle, with respect to the first route on the roadway system;
generating, in response to the receiving of the order data, second route data that indicates a second route on the roadway system and a second travel-schedule, for a self-driving delivery vehicle, with respect to the second route on the roadway system, wherein the second travel-schedule at least partially defines a rendezvous area along a portion of the second route that is common to the first route;
dispatching the self-driving delivery vehicle from a source of the product along the second route to the rendezvous area; and
causing the self-driving delivery vehicle to approach the receiving vehicle within the rendezvous area to transfer the product from the self-driving delivery vehicle to the receiving vehicle.

9. The method of claim 8, further comprising:
determining source-location data corresponding to a plurality of available sources for the product; and
selecting, based on the source-location data and the first route data, the source of the product from the plurality of available sources for the product.

10. The method of claim 8, further comprising identifying the receiving vehicle within the rendezvous area based on a characteristic of at least one of the receiving vehicle or a client computing device corresponding to the order data.

11. The method of claim 10, further comprising:
in response to the identifying of the receiving vehicle, causing the self-driving delivery vehicle to extend a robotic-arm that is supporting the product toward a window of the receiving vehicle; and
causing the self-driving delivery vehicle to retract the robotic-arm when the product has been transferred into the receiving vehicle.

12. The method of claim 8, further comprising:
receiving preliminary order data indicating at least some of the first route data and at least one of the selection of the product or a classification associated with the product;
determining, based on the preliminary order data, a plurality of product-acquisition options for scheduling a delivery to the receiving vehicle along the first route, wherein the selection corresponds to an individual product-acquisition option of the plurality of product-acquisition options.

13. The method of claim 8, wherein the determining of the first route data includes receiving at least one of calendar data defining an appointment location, the first route data from a navigation module of at least one of the receiving vehicle, or a client computing device corresponding to the order data and generating the determining of the first route data based on at least one of calendar data defining an appointment location, the first route data from a navigation module of at least one of the receiving vehicle, or a client computing device corresponding to the order data.

14. The method of claim 13, further comprising receiving, from the navigation module, location data that indicates one or more substantially real-time locations of the receiving vehicle along the first route, wherein the causing of the self-driving delivery vehicle to approach the receiving vehicle is based at least in part on the one or more substantially real-time locations of the receiving vehicle.

15. The method of claim 8, wherein determining the first route data includes:
determining route-deviation data associated with deviating from a direct route to one or more available rendezvous areas from an initial location of the receiving vehicle and a destination location of the receiving vehicle; and
causing at least one of the receiving vehicle or a client computing device corresponding to the order data to communicate at least some of the route-deviation data to enable a user to select the rendezvous area from the one or more available rendezvous areas.

16. A system comprising:
at least one processor; and
at least one computer storage media storing instructions that are executable by the at least one processor to:
obtain order data indicating a selection of a product for delivery by a self-driving delivery vehicle to a receiving vehicle that is operating on a roadway system;
determine first route data that indicates a first travel-schedule that the receiving vehicle is expected to travel along a first route on the roadway system;
in response to receiving the order data, generate second route data that indicates a second travel-schedule for the self-driving delivery vehicle to travel along a second route on the roadway system, wherein the second travel-schedule at least partially defines a rendezvous area along a portion of the second route that is common to the first route;
dispatch the self-driving delivery vehicle from an initial-location along the second route to the rendezvous area; and
cause the self-driving delivery vehicle to approach the receiving vehicle within the rendezvous area and to open a compartment containing the product to facilitate a transfer of the product from the self-driving delivery vehicle to the receiving vehicle.

17. The system of claim 16, wherein the instructions are further executable by the at least one processor to:
cause the self-driving delivery vehicle to maintain a relative position of the self-driving delivery vehicle with respect to the receiving vehicle while the receiving vehicle is traveling along the first route; and
causing the self-driving delivery vehicle to extend a robotic-arm that is supporting the compartment containing the product toward the receiving vehicle while maintaining the relative position with respect to the receiving vehicle.

18. The system of claim 16, wherein the instructions are further executable by the at least one processor to establish a communications link between a first autopilot module of the receiving vehicle and a second autopilot module of the self-driving delivery vehicle, wherein the communications link facilitates a transfer of at least one of maneuver data and/or obstacle data between the first autopilot module and the second autopilot module to enable the self-driving delivery vehicle to maintain a relative position with respect to the receiving vehicle.

19. The system of claim 16, wherein the first route data includes at least travel pattern data associated with at least one of the receiving vehicle and/or a client computing device corresponding to the order data.

20. The system of claim 16, wherein the self-driving delivery vehicle is configured to physically alter the product from a first material-form to a second material-form by at least one of performing at least one of a heating operation to transfer heat into one or more components of the product or an assembly operation to physically combine one or more components of the product.
